(19) United States
(12) Patent Application Publication
(10) Pub. No.: US 2003/0079222 A1
(43) Pub. Date: Apr. 24, 2003

(54) System and method for distributing perceptually encrypted encoded files of music and movies

(76) Inventors: Patrick Oscar Boykin, Oakland, CA (US); Riccardo Boscolo, Culver City, CA (US); Jesse Bridgewater, West Los Angeles, CA (US)

Correspondence Address: W. Edward Johansen, 11661 San Vicente Boulevard, Los Angeles, CA, 90049, US

(21) Appl. No.: 09/907,471

(22) Filed: Jul. 16, 2001

Related U.S. Application Data
(63) Continuation-in-part of application No. 09/891,137, filed on Jun. 25, 2001.
Application No. 09/891,137 is a continuation-in-part of application No. 09/684,724, filed on Oct. 6, 2000.
Application No. 09/891,137 is a continuation-in-part of application No. 09/737,458, filed on Dec. 14, 2000.
Application No. 09/891,137 is a continuation-in-part of application No. 09/891,147, filed on Jun. 25, 2001.
Application No. 09/891,147 is a continuation-in-part of application No. 09/740,717, filed on Dec. 19, 2000.
Application No. 09/891,147 is a continuation-in-part of application No. 09/695,449, filed on Oct. 23, 2000.
Application No. 09/891,147 is a continuation-in-part of application No. 09/737,458, filed on Dec. 14, 2000.

(51) Int. Cl. H04N 7/167; H04N 7/16; H04L 9/00; H04N 7/00; H04N 11/00

(52) U.S. Cl. 725/31; 725/135; 348/461; 380/210; 380/211; 380/217; 380/282

(57) ABSTRACT

The present invention is a system for transmitting a digital signal which includes an encoder, a perceptual encrypting system and a transmitter. The encoder band-compression encodes a first digital signal as encoded data defining an image. The perceptual encrypting system is coupled to the and perceptually encrypts the encoded data to generate restricted video data as perceptually encrypted encoded data. The transmitter is coupled to the perceptual encrypting system and transmits the perceptually encrypted encoded data. A combined receiver and decoder for the restricted video data as perceptually encrypted encoded data includes a receiver and a decoder. The receiver receives the perceptually encrypted encoded data. The decoder is coupled to the receiver and decodes the perceptually encrypted encoded data to generate low quality video.

This is a continuation-in-part of an application filed Jun. 25, 2001 under Pat. Ser. No. 09/684,724 which is a continuation-in-part of an application filed Oct. 6, 2000 under Pat. Ser. No. 09/684,724 and a continuation-in-part of an application filed Dec. 14, 2000 under Pat. Ser. No. 09/737,458, a continuation-in-part of an application filed Jun. 25, 2001 under Pat. Ser. No. 09/891147 which is a continuation-in-part of application filed filed Dec. 19, 2001 under Pat. Ser. No. 09/740,717, a continuation-in-part of an application filed Oct. 6, 2000 under Pat. Ser. No. 09/684,724, a continuation-in-part of an application filed Oct. 23, 2000 un Pat. Ser. No. 09/695,449, a continuation-in-part of an application filed Dec. 14, 2000 under Ser, No. 09/737,458 and a continuation-in-part of an application filed Dec. 19, 2000 under Pat. Ser. No. 09/740,717.

### BACKGROUND OF THE INVENTION

The present invention relates to perceptual encryption of files of either high fidelity music or high quality video to generate files of either restricted fidelity music or restricted quality video as perceptually encrypted encoded data in a compression format. The files of either restricted music or restricted quality video can either be decoded and played as either restricted fidelity or restricted quality video or be decrypted, decoded and played as either high fidelity music or high quality video.

MPEG standards determine the encoding and decoding conditions of motion pictures in the form of a flow of video digital data and a flow of audio digital data. The MPEG standards define the encoding conditions of motion pictures, whether associated or not with a sound signal, for storing in a memory and/or for transmitting using Hertzian waves. The MPEG standards also define the encoding conditions of the individual picture sequences that form the motion picture to be restored on a screen. Digital pictures are encoded in order to decrease the amount of corresponding data. Encoding generally uses compression techniques and motion estimation. The MPEG standards are used to store picture sequences on laser compact disks, interactive or not, or on magnetic tapes. The MPEG standards are also used to transmit pictures on telephone lines.

U.S. Pat. No. 6,233,682 teaches a system which permits purchasing audio music files over the Internet. Apersonal computer user logs onto the vendor's web site and browses the songs available for purchase.

U.S. Pat. No. 6,256,423 teaches an intra-frame quantizer selection for video compression which divides an image. The image is divided into one or more regions of interest with transition regions defined between each region of interest and the relatively least-important region. Each region is encoded using a single selected quantization level. The quantizer values can differ between different regions. In order to optimize video quality while still meeting target bit allocations, the quantizer assigned to a region of interest is lower than the quantizer assigned to the corresponding transition region, which is itself preferably lower than the quantizer assigned to the background region. A non-iterative scheme can be more easily implemented in real time. The intra-frame quantizer selection for video compression enables a video compression algorithm to meet a frame-level bit target, while ensuring spatial and temporal smoothness in frame quality, thus resulting in improved visual perception during playback.

U.S. Pat. No. 6,256,392 teaches a signal reproducing apparatus which prohibits both copying and unauthorized use. The apparatus includes a copying management information decision circuit, a protect signal generating circuit, a mixing circuit, a descrambling circuit and a scrambling circuit. The copying management information decision circuit discriminates the state of the copying management information read out from each header of a data sector and within the TOC. The protect signal generating circuit generates a protect signal based on the discrimination signal. The mixing circuit mixes a protect signal in a vertical blanking period of an analog video signal D/A converted from digital video data reproduced from an optical disc D. The descrambling circuit descrambles the digital data based on the copying management information. The scrambling circuit descrambles the digital data. The apparatus enables prohibition of unauthorized analog copying and digital copying inhibition of serial generational copying and prohibition of unauthorized analog and digital copying simultaneously.

U.S. Pat. No. 5,963,916 teaches a system for on-line user-interactive multimedia based point-of-preview which provides for a network web site and accompanying software and hardware for allowing users to access the web site over a network such as the internet via a computer. The user is uniquely identified to the web site server through an identification name or number. The hardware associated with the web site includes storage of discrete increments of pre-selected portions of music products for user selection and preview. After user selection, a programmable data processor selects the particular pre-recorded music product from data storage and then transmits that chosen music product over the network to the user for preview. Subscriber selection and profile data (i.e. demographic information) can optionally be collected and stored to develop market research data. The system contemplates previewing of audio programs, such as music on compact discs, video programs, such as movies, and text from books and other written documents. The network web site can be accessed from a publicly accessible kiosk, available at a retail store location, or from a desk top computer. The 1980s witnessed a tremendous rise in consumer demand for home entertainment products, such as the compact disc player. Wide consumer acceptance has been the result of more affordable ownership costs, superior fidelity (compared with LPs and cassettes) and remarkable ease-of-use. In the United States alone, total sales of compact disc players skyrocketed from 1.2 million units in 1985 to over 17 million units in 1989 (over three times the growth rate of VCRs). Compact disc players now represent one third of all new audio component sales with projections pointing to total U.S. sales topping 30 million players in the U.S. by 1991—making the compact disc player the fastest growing consumer electronics product in the last twenty-five years. Despite the explosion of compact disc player sales, most consumers own very few compact discs (studies indicate the average compact disc player owner possesses only nine discs). This is due to the fact that when it comes to purchasing a specific compact disc, the consumer is faced with several constraints and dilemmas. Compact discs are roughly twice the retail price ($14-$16) of LPs and cassettes and as a result, consumers are more reluctant to explore new and/or unproven artists for fear of wasting money. There is the issue of “selection stress,” a common problem for the average music buyer who is confronted with an enormous catalogue from which to choose and few mechanisms to assist her in evaluating these choices. This is exemplified by typical retail music stores which have developed the “superstore” format in order to promote its products. Unfortunately, the salespeople generally have not kept up with the sophistication of the market so consumers are at a clear disadvantage. Consumers often can neither sample nor interact with the product while they are in the music store and they cannot return products they do not like. Therefore, although many consumers wish to build larger music collections, purchasing decisions are often risky and mistakes can be costly. At the artist level, the proliferation of new music markets, styles and tastes has caused the number of record labels to increase dramatically. The record industry has expanded from several major labels in the 1970s to more than 2,500 distributed and independent labels today. Each year more than 2,500 new artists are introduced into an already crowded market. Label executives have no way to test market their respective acts or albums before dollars are committed to the production, promotion and distribution process. There is no current methodology to provide consumer exposure to a particular artist's work outside of radio and television or concert tours. Retail music stores heavily utilized print media to draw attention to new and old labels and special promotions. Music labels recognize this and consequently subsidized these efforts to promote their individual artists. The problem of consumer awareness is aggravated by the glut of records on the market. The glut of records inhibits consumer exposure at the retail level and over the airways. Because each record label is responsible for the recruitment, development and promotion of their artists, some record companies have been compelled to establish marketing promotions where records are given away to promote awareness of certain acts.

Labels managers have acknowledged that because a greater investment of time, money and creativity is required to develop many of today's acts, they are more likely than ever to cut short promotion in order to cut their losses quickly on albums that do not show early signs of returning the investment. This strongly limits the potential for success because some artists require longer and more diverse promotion in order to succeed. In order to provide for greater consumer-exposure of artist's works, a number of different devices have been designed. For example, a music sampler called PICS Previews has been developed. Although it permits some in store sampling, its use is severely limited because its primary format is based on a hardware configuration which is not easily modifiable. The PICS Preview device incorporates a television screen with a large keypad covered with miniature album covers, and these are locked into a laser disk player. A master disk holds a fixed number of videoclips—usually about 80—and is used as the source of music information. The consumer is permitted to view a video representing a selection from the album. Information from only those artists who have made a video and who are featured on the PICS preview system can be accessed. The consumer cannot make her own selection. The selections are not necessarily those that are in the store inventory. Another in-store device, the Personics System, provides users with the ability to make customized tapes from selected music stored on the machines. A drawback with this device is that it is expensive to use and time consuming to operate. Exposure to various artists is limited. The device is viewed by record production companies as cannibalistic. Therefore record production companies have been reluctant to permit new songs from their top artists to be presented on these devices. Perhaps the greatest advance in market exposure of a prerecorded product as of its issuance is U.S. Pat. No. 5,237,157 which is directed to a user-interactive multi-media based point-of-preview system. Interactive digital music sampling kiosks are provided to the retail music industry. The listening booth of the 1950s has been reborn and through the application of software and hardware technology has been brought into the next century. The kiosk acts as a computer age “listening booth.” The consumer, as a subscriber, is exposed to her potential purchases by being offered the ability to preview music before purchasing selections at record stores. The guesswork is thereby taken out of music purchasing by allowing consumers to make more informed purchasing decisions comparable with those available for other consumer products. The kiosk provides access to music products through the sampling of individual selections as discrete increments of information. This allows the subscriber to make more educated purchases. The kiosk thereby dramatically changes the way in which consumers purchase music. This increases buying activity and improves overall customer satisfaction. The kiosk stimulates sales gains for the record stores and provides record companies a cheaper and more effective promotional alternative which can sample consumer opinions at the point-of-sale level. The device utilizes a graphical interface software, a hi-resolution touchscreen monitor, and unprecedented storage capacity. Each system can offer the consumer the ability to preview selections from up to 25,000 albums, thus allowing more informed purchasing decisions by listening to songs on an album in a mode as uninhibited as using a telephone. The customer simply takes any music selection in the store display and approaches the kiosk. After scanning their user/subscriber card (free to the user and available at the store counter) across the UPC bar code reader, the customer scans their chosen audio selection. The touch screen monitor then displays an image of the album cover in full color with songs from the album. The user simply touches the name of the desired song on the screen and through the privacy of headphones listens to a 30 second clip of the audio program. Additional options include full motion MTV videos or Rolling Stone record reviews. The listening booth of the 1950s is effectively reborn and improved and through the application of software and hardware technology, brought into the 1990s. Because of the high level of software content, the device remains flexible and dynamic. The interactive touch-screen can be programmed to accommodate multiple applications running under one environment on one system. Touch-screen interface can be continually modified with additional features added over time. This encourages subscriber interest and permits a competitive advantage over competitors who have locked their design into predominately hardware based configurations with little value-added software content. The selection and input data from the subscriber is collected from each kiosk location and is transmitted to a central database for analysis by the central processing unit. Through the central processing unit, the subscriber selection and subscriber profile data can be analyzed, packaged, and distributed as information products to the entire music industry as timely and focused market research.

U.S. Pat. No. 5,909,638 teaches system which captures, stores and retrieves movies recorded in a video format and stored in a compressed digital format at a central distribution site. Remote distribution locations are connected through fiber optic connections to the central distribution site. The remote sites maybe of one of two types: a video retail store or a cable television (CATV) head end. In the case of a video retail store VHS videotapes or any other format videotapes or other video media may be manufactured on-demand in as little as three to five minutes for rental or sell-through. In a totally automated manufacturing system the customers can preview and order movies for rental and sale from video kiosks. The selected movie is either retrieved from local cache storage or downloaded from the central distribution site for manufacturing onto either a blank video-tape or a reused videotape. One feature of the system is the ability to write a two-hour videotape into a Standard Play (SP) format using a high-speed recording device. A parallel compression algorithm which is based on the MPEG-2 format is used to compress a full-length movie into a movie data file of approximately four gigabytes of storage. The movie data file can be downloaded from the central site to the remote manufacturing site and written onto a standard VHS tape using a parallel decompression engine to write the entire movie at high speeds onto a standard VHS videotape in approximately three minutes.

U.S. Pat. No. 5,949,411 teaches a system for previewing movies, videos and music. The system has a host data processing network connected via modem with one or more media companies and with one or more remote kiosks to transmit data between the media companies and the kiosks. A user at a remote kiosk can access the data. A touch screen and user-friendly graphics encourage use of the system. Video-images, graphics and other data received from the media companies are suitably digitized, compressed and otherwise formatted by the host for use at the kiosk. This enables videos, such as movies, and music to be previewed at strategically located kiosks. The data can be updated or changed, as desired, from the host.

U.S. Pat. No. 6,038,316 teaches an encryption module and a decryption module for enabling the encryption and decryption of digital information. The encryption module includes logic for encrypting with a key the digital information. The decryption module includes logic for receiving a key and decrypting with the key the encrypted digital information. The decryption logic uses the key to make the content available to the user.

U.S. Pat. No. 6,038,591 teaches a system which delivers programmed music and targeted advertising messages to Internet based subscribers. The system includes a software controlled microprocessor based repository in which the dossiers of a plurality of the subscribers are stored and updated, musical content and related advertising are classified and matched. A subscriber has an appropriate microprocessor based device capable of selecting information and receiving information from the Internet. The subscriber receives the programmed music and matched advertisements from the repository over the Internet.

There are current technologies for protecting the copyright of digital media are based on a full encryption of the encoded sequence. Full encryption does not allow the user any access to the data unless a key is made available. There are alternative approaches to ensure rights protection. These approaches are based on “watermarking” techniques which aim to uniquely identify the source of a particular digital object thanks to a specific signature hidden in the bit stream and invisible to the user.

The distribution of movies for viewing in the home is one of the largest industries in the world. The rental and sale of movies on videotape is a constantly growing industry amounting to over $15 billion dollars in software sales in the United States in 1995. The most popular medium for distributing movies to the home is by videotape, such as VHF. One reason for the robust market for movies on videotape is that there is an established base of videocassette recorders in people's homes. This helps fuel an industry of local videotape rental and sale outlets around the country and worldwide. The VHS videotape format is the most popular videotape format in the world and the longevity of this standard is assured due to the sheer numbers of VHS videocassette players installed worldwide. There are other mediums for distributing movies such as laser disk and 8 mm tape. In the near future, Digital Versatile Disk technology will probably replace some of the currently used mediums since a higher quality of video and audio would be available through digital encoding on such a disk. Another medium for distributing movies to the home is through cable television networks. These networks currently provide pay-per-view capabilities and in the near future, direct video on-demand. For the consumer, the experience of renting or buying the videotape is often frustrating due to the unavailability of the desired titles. Movie rental and sales statistics show that close to 50% of all consumers visiting a video outlet store do not find the title that they desire and either end up renting or buying an alternate title or not purchasing anything at all. This is due to the limited space for stocking many movie titles within the physical confines of the store. With limited inventory, video stores supply either the most popular titles or a small number of select titles. Increasing the inventory of movie titles is in direct proportion to the shelf capacity of any one video-store. Direct video distribution to the home is also limited by the availability of select and limited titles at predefined times. Pay-per-view services typically play a limited fare of titles at predefined times offering the consumer a very short list of options for movie viewing in the home. Video on-demand to the home is limited by the cable television head end facilities in its capacity to store a limited number of titles locally. All of the aforementioned mechanisms for distributing movies to the consumer suffer from inventory limitations. An untapped demand in movie distribution results if the inventory to the consumer can be made large enough and efficient enough to produce movies-on-demand in the format which the consumer desires. There is a need for the ability to deliver movies on-demand with a virtually unlimited library of movies on any number of mediums such as VHS videotape, 8 mm videotape, recordable laser disk or DVD. Some systems have addressed the need for distribution of digital information for local manufacturing, sale and distribution.

U.S. Pat. No. 5,793,980 teaches an audio-on-demand communication system. The system provides real-time playback of audio data transferred via telephone lines or other communication links. One or more audio servers include memory banks which store compressed audio data. At the request of a user at a subscriber PC, an audio server transmits the compressed audio data over the communication link to the subscriber PC. The subscriber PC receives and decompresses the transmitted audio data in less than real-time using only the processing power of the CPU within the subscriber PC. High quality audio data is compressed according to loss-less compression techniques and is transmitted together with normal quality audio data. Meta-data, or extra data, such as text, captions and still images, is transmitted with audio data and simultaneously displayed with corresponding audio data. The audio-on-demand system has a table of contents. The table of contents indicates significant divisions in the audio clip to be played and allows the user immediate access to audio data at the listed divisions. Servers and subscriber PCs are dynamically allocated based upon geographic location to provide the highest possible quality in the communication link.

U.S. Pat. No. 6,064,748 teaches an apparatus for embedding and retrieving an additional data bit-stream in an embedded data stream, such as MPEG. The embedded data is processed and a selected parameter in the header portion of the encoded data stream is varied according to the embedded information bit pattern. Optimization of the encoded data stream is not significantly affected. The embedded information is robust in that the encoded data stream would need to be decoded and re-encoded in order to change a bit of the embedded information. As relevant portions of the header are not scrambled to facilitate searching and navigation through the encoded data stream, the embedded data can generally be retrieved even when the encoded data stream is scrambled.

U.S. Pat. No. 6,081,784 teaches a method of encoding an audio signal which includes the step of splitting the audio signal into a first signal component thereby permitting only comprehension of its contents and a second signal component for high quality reproduction. The method also includes the step of encrypting and encoding only the second signal component. U.S. Pat. No. 6,081,784 also teaches that it has been difficult to encrypt high-efficiency encoded signals so that lowering of the compression efficiency is evaded despite the fact that the code-string as given is meaningful for usual reproducing means. U.S. Pat. No. 6,081,784 further teaches that if, when the PCM signals are high-efficiency encoded prior to scrambling, the information volume is diminished by exploiting the psycho-acoustic characteristics of the human auditory system. The scrambled PCM signals can not necessarily be reproduced at a time point of decoding the high-efficiency encoded signals to render it difficult to de-scramble the signals correctly.

U.S. Pat. No. 6,151,634 teaches an audio-on-demand communication system which provides real-time playback of audio data transferred via telephone lines or other communication links.

U.S. Pat. No. 5,721,778 teaches a digital signal transmitting method, a digital signal receiving apparatus, and a recording medium which ensure the security of fee-charged software information. When an image providing predetermined services is transmitted, a band-compression coded digital video signal is given first-encryption processing and then the digital signal is further given encryption processing and transmitted. Therefore, double security can be added to the video signal and a digital signal transmitting method where its security is more firmly ensured can be realized.

U.S. Pat. No. 6,205,180 teaches a device which de-multiplexes data encoded according to the MPEG standard in the form of a data flow including system packets, video packets and audio packets. The device independently organizes according to the nature (system packets, video packets and audio packets) of the data included in the packets and the storing of the data in various registers. The encoding and decoding conditions as defined by the MPEG standards can be obtained from standard organizations. The decoding of data encoded according to one of the MPEG standards uses a separation of the data included in the data flow according to its nature. The video data is separated from the audio data, if any, and the audio and video data are separately decoded in suitable audio and video decoders. The data flow also includes system data. The system data includes information relating to the encoding conditions of the data flow and is used to configure the video and audio decoder(s) so that they correctly decode the video and audio data. The separation of the various data included in the data flow is done according to their nature. The separation is called the system layer. The system, audio and video data are separated before the individual decoding of the audio and video data.

U.S. Pat. No. 6,097,843 teaches a compression encoder which encodes an inputted image signal in accordance with the MPEG standard. The compression and decompression different is from a main compression encoding which is executed by a motion detection/compensation processing circuit, a discrete cosine transforming/quantizing circuit, and a Huffman encoding circuit. The compression and decompression are executed by a signal compressing circuit and a signal decompressing circuit. By reducing an amount of information that is written into a memory provided in association with the compression encoding apparatus, a necessary capacity of the memory can be decreased.

U.S. Pat. No. 6,157,625 teaches in an MPEG transport stream, each audio signal packet is placed after the corresponding video signal packet when audio and video transport streams are multiplexed.

U.S. Pat. No. 6,157,674 teaches an encoder which compresses and encodes audio and/or video data by the MPEG-2 system, multiplexing the same and transmitting the resultant data via a digital line. When generating a transport stream for transmitting a PES packet of the MPEG-2 system, the amounts of the compressed video data and the compressed audio data are defined as whole multiples of the amount of the transport packet (188 bytes) of the MPEG-2 system, thereby to bring the boundary of the frame cycle of the audio and/or video data and the boundary of the transport packet into coincidence.

U.S. Pat. No. 6,115,689 teaches an encoder and a decoder. The encoder includes a multi-resolution transform processor, such as a modulated lapped transform (MLT) transform processor, a weighting processor, a uniform quantizer, a masking threshold spectrum processor, an entropy encoder and a communication device, such as a multiplexor (MUX) for multiplexing (combining) signals received from the above components for transmission over a single medium. The decoder includes inverse components of the encoder, such as an inverse multi-resolution transform processor, an inverse weighting processor, an inverse uniform quantizer, an inverse masking threshold spectrum processor, an inverse entropy encoder, and an inverse MUX.

U.S. Pat. No. 5,742,599 teaches a method which supports constant bit rate encoded MPEG-2 transport over local Asynchronous Transfer Mode (ATM) networks. The method encapsulates constant bit rate encoded MPEG-2 transport packets, which are 188 bytes is size, in an ATM AAL-5 Protocol Data Unit (PDU), which is 65,535 bytes in size. The method and system includes inserting a plurality of MPEG-2 transport packets into a single AAL-5 PDU, inserting a segment trailer into the ATM packet after every two MPEG packets, and then inserting an ATM trailer at the end of the ATM packet. MPEG-2 transport packets are packed into one AAL-5 PDU to yield a throughput 70.36 and 78.98 Mbits/sec, respectively, thereby supporting fast forward and backward playing of MPEG-2 movies via ATM networks.

U.S. Pat. No. 6,092,107 teaches a system which allows for playing/browsing coded audiovisual objects, such as the parametric system of MPEG-4.

U.S. Pat. No. 6,151,634 teaches an audio-on-demand communication system which provides real-time playback of audio data transferred via telephone lines or other communication links.

U.S. Pat. No. 6,248,946 teaches a system which delivers multimedia content to computers over a computer network, such as the Internet. The system includes a media player. The media player may be downloaded onto a user's personal computer. The media player includes a user interface. The user interface allows a listener to search an online database of media selections and build a custom play-list of exactly the music selections desired by the listener. The multimedia content delivery system delivers advertisements which remain visible on a user's computer display screen at all times when the application is open, for example, while music selections are being delivered to the user. The advertisements are displayed in a window which always remains on a topmost level of windows on the user's computer display screen, even if the user is executing one or more other programs with the computer.

Multimedia applications have become an important driver for the growth of both the personal computer market and the Internet, indicating their popularity with users. It is apparent that many people enjoy listening to music or watching video programs via their computers, either in a standalone mode or, often, while performing other functions with the computer. In the office environment, an increasing number of people work with a personal computer. In that case, while working at their computers some workers may play music selections from a compact disc (CD), using the CD-ROM drive and audio processing components present in most new PCs. Also, someone working at home on their personal computer may listen to music while they work. Moreover, as more home computers are equipped and connected with hi-fidelity speaker systems, people may use a home computer as a audio music system, even when they are not using the computer for any other purposes. However, it is sometimes the case that a person wants to hear one or more particular songs for which they do not presently have a copy of the recording. Also, it is often the case that a person wants to hear one or more music selections from a particular recording before making a purchase decision. And sometimes an individual may just want to hear a collection of songs from one particular artist. In other words, listeners desire the freedom and flexibility to choose exactly what songs they hear, in the order they choose, and at times of their own choosing. Of course radio stations play music selections to which an individual may listen. Some PCs are equipped with radio tuners so that an individual may listen to broadcast radio stations via his or her PC. Moreover, many broadcast radio stations also transmit their broadcast audio signal over the Internet. And other specialized “Internet radio stations” have been developed which transmit a radio-like audio signal over the Internet only from a web site to which listeners connect. Thus, individuals may listen to many radio stations via a personal computer connected to the Internet. One advertisement-sponsored Internet web, SPINNER.COM, allows a computer user to select from and listen to multiple Internet radio stations. Each Internet radio station is tailored to a particular musical format. SPINNER.COM uses its own downloadable music player for listeners to connect over the Internet with streaming audio servers associated with the SPINNER.COM radio stations. SPINNER.COM earns revenue to support its music service from Internet “banner ads” which appear in the music player window. A user may set the SPINNER.COM music player to remain on a topmost level of windows displayed on the user's computer display screen. The user may also allow the SPINNER.COM music player to be minimized or covered with other open windows on a user's computer display screen, so that the advertisements may not actually be viewed by the listener. In other words, the display of advertisements on the user's computer display screen is fully within the user's control. So the value of the advertisements to the advertisers is diminished. With Internet radio stations, as with AM and FM radio stations, the songs are played are chosen by a program director and can not be tailored to each individual listener's choices. Neither broadcast nor Internet radio stations meet the desire for total flexibility of music choice by a listener. Other Internet music services have been developed which allow a listener more freedom to choose the music selections that he or she wants to hear. Internet music services such as RADIO SONICNET and RADIOMOI.COM allow a listener a limited capability to program his or her own “customized” radio station. RADIO SONICNET allows a listener to select and rank musical artists and musical categories of interest to the listener to create a customized radio station. RADIO SONICNET then provides the listener with a list of musical artists whose music will be played on the radio station. Individual song selections, play frequency, and song order are all determined by the RADIO SONICNET music service without any direct listener control. To create a “custom” radio station, a listener interacts with musical preference forms supplied to his or her computer's existing Internet web browser over an Internet connection with the RADIO SONICNET web site. All songs are delivered from the RADIO SONICNET server(s) to the listener's computer over an Internet connection with the listener's web browser, and are played on the listener's computer by one or more plug-ins or helper applications associated with the web browser. RADIO SONICNET earns revenue to support its music service from Internet “banner ads” which are displayed in the listener's browser window on the user's computer display screen while music selections are streamed to his or her computer. However, the user's web browser may be minimized or covered with other open windows on the computer display screen, so that the user may not view the advertisements. So, once again, the value of the advertisements to the advertisers is diminished. Meanwhile, RADIOMOI.COM allows a listener to search a database of available songs by song title, artist, etc., and to add particular songs to a play-list for a “custom” radio station for that listener. The database of songs is divided into non-interactive and interactive songs. Once the listener has completed his or her play-list, he or she must submit it to the RADIOMOI music service for approval. The music service then checks the play-list against a predetermined set of rules and informs the listener whether the play-list has been approved or rejected. A play-list of only interactive songs is automatically approved. If the Play-list is approved, then the listener may request that the music service begin streaming the songs on the play-list to the listener's computer via the Internet. However, the play-list may be rejected by the music service for one or more reasons, such as having too many consecutive songs by a same artist or from a same album or CD recording. In that case, the listener must edit his or her play-list to conform to the RADIOMOI music service's rules or to contain only interactive songs. To create a “custom” radio station with RADIOMOI, a listener interacts with song and artist selection forms supplied to his or her computer's existing Internet web browser over an Internet connection with the RADIOMOI.COM web site. All songs are delivered from the RADIOMOI.COM server(s) to the listener's computer over an Internet connection with the listener's Internet web browser, and are played on the listener's computer by one or more plug-ins or helper applications associated with the web browser. RADIOMOI.COM earns revenue to support its music service from Internet “banner ads” which are displayed in the Internet browser window on the user's computer display screen while music selections are streamed to his or her computer. However, as with RADIO SONICNET, the user's web browser may be minimized or covered with other open windows on a user's computer display screen, so that the ads may not be viewed by the listener. Accordingly, all of these previous multimedia delivery systems suffer from several disadvantages. None of these systems is well adapted to providing an effective advertisement vehicle to support a free Internet music service. In these systems, the music player or Internet browser through which the music is being delivered can be minimized or covered on a user's computer display screen by other windows open for other active programs. So any advertisements being delivered for display through the music player are not necessarily visible to the user and may not be viewed by the user. This diminishes the value of the advertisements to sponsors, and therefore reduces the amount a sponsor will pay to have the advertisement delivered. In turn, the reduced advertising revenues limit the available funds for purchasing music licensing rights, distribution bandwidth, hardware, and other resources for supporting a free Internet music service.

U.S. Pat. No. 6,011,761 teaches a transmission system which transmits compressed audio data selected by a user from compressed audio data stored in a server to a client located remote from the server. If the state of the recording medium loaded on the client side is normal and/or the money deposited on the client side is sufficient to permit charging the user, the selected compressed audio data starts to be transmitted from the server. If the state of the recording medium loaded on the client side is not normal and/or the money deposited on the client side is insufficient to permit charging the user, transmission of the selected compressed audio data from the server is inhibited.

U.S. Pat. No. 6,247,130 teaches a system which permits purchasing of audio music files over the Internet. The PC user logs onto the vendor's web site and browses the songs available for purchase. The songs can be arranged by artist and music style. The vendor can provide suggestions on the web site, directing the PC user to songs that might be desirable, based on that PC user's previous purchases, her indicated preferences, popularity of the songs, paid advertising and the like. If interested in a song, the PC user has the option of clicking on a song to “pre-listen” to it—hearing a 20-second clip, for example. If the PC user then wishes to purchase the song, she can submit her order by clicking on the icons located next to each song/album. The order will be reflected in the shopping basket, always visible on the screen. As the PC user selects more items, each and every item is displayed in the shopping basket. At any point in time, the PC user can review her selections, deleting items she no longer desires. Consumers may access the web site via a personal computer or any other wired or wireless Internet access device, such as WebTV, personal digital assistant, cellular telephone, etc., to obtain a variety of services and products. For instance, a consumer may browse through artists, tracks or albums, pre-listen to a portion of the song and purchase the selected song either by downloading the digital data to her computer hard drive or by placing a mail order for a compact disk (CD). A specially encoded or encrypted MP3 files called “NETrax” are delivered from a server over the Internet or cable services to the end consumers' home PC. The Internet has offered opportunities for electronic commerce of massive proportions. Among other things, distribution of music over the computer-implemented global network is a well suited application of e-commerce, whereby consumers can easily and quickly find and purchase individual tracks or entire albums. A need therefore exists for a system and method that provide a music web site that is comprehensive, versatile, user-friendly, and protects the proprietary rights of artists and other rights holders.

U.S. Pat. No. 6,105,131 teaches a distribution system. The distribution system includes a server.

U.S. Pat. No. 5,636,276 teaches a distribution system. The distribution system distributes music information in digital form from a central memory device via a communications network to a terminal.

U.S. Pat. No. 5,008,935 teaches a method for encrypting data for storage in a computer and/or for transmission to another data processing system.

Stimulated by the technological revolution in both, networking technology, such as the Internet, and highly efficient perceptual audio coding methods such as MPEG-1 Layer-3, commonly referred to as MP3, a tremendous amount of music piracy has emerged. There have been many attempts to combat music piracy. In one such attempt an audio scrambler has been developed. The audio scrambler operates by encrypting selected parts of an encoded audio bit-stream instead of encrypting entire data blocks. These protected parts represent spectral values of the audio signal. As a result, decoding of a protected bit-stream without a decrypter and a key will produce a distorted and annoying audio signal. A consequence of this scheme is that the decryption cannot be separated from the decoding. The audio scrambler has a high degree of security, because a deep knowledge of the bit-stream structure is needed to reach the protected parts. The low complexity of this scheme makes it possible to implement the audio scrambler on real-time decoding systems like portable devices without substantially increasing the computational workload.

In another such attempt the Secure Digital Music Initiative group has developed industry standards which it hopes will not only enable music distribution via the Internet, but also ensure the proper honoring of all intellectual property rights which is associated with the delivered content. One of the most important technical means for achieving this goal are secure envelope techniques which package the content into a secure container by means of ciphering all or part of the payload with well-known encryption techniques. In this way, access to the payload can be restricted to authorized persons. Such protection schemes can be applied to any kind of digital data. However, the versatility of these schemes implies that the secured data must first be decrypted before subsequent decoding.

U.S. Pat. No. 5,818,933 teaches a copyright control system that performs access control to copyright digital information. The copyright control system is equipped with decryption hardware. The decryption hardware accepts encrypted copyright digital information and decrypts the encrypted digital information using a decryption key obtained from a copyright control center.

U.S. Pat. No. 6,038,316 teaches an information processing system which includes an encryption module and a decryption module for enabling the encryption of digital information to be decrypted with a decryption key. The encryption module includes logic for encrypting the digital information and distributing the digital information. The decryption module includes logic for the user to receive a key. The decryption logic then uses the key to make the content available to the user.

U.S. Pat. No. 5,949,876 teaches a system for secure transaction management and electronic rights protection. Computers are equipped to ensure that information is accessed and used only in authorized ways and to maintain the integrity, availability and/or confidentiality of the information.

U.S. Pat. No. 6,052,780 teaches a digital information protection system which allows a content provider to encrypt digital information without requiring either a hardware or platform manufacturer or a content consumer to provide support for the specific form of corresponding decryption. Suitable authorization procedures also enable the digital information to be distributed for a limited number of uses and/or users, thus enabling per-use fees to be charged for the digital information.

In 1987, the IIS started to work on perceptual audio coding in the framework of the EUREKA project EU147, Digital Audio Broadcasting. In a joint cooperation with the University of Erlangen, the IIS finally devised a very powerful algorithm which is standardized as ISO-MPEG Audio Layer-3 (IS 10172-3 and IS 13818-3). Without data reduction, digital audio signals typically consist of 16 bit samples recorded at a sampling rate more than twice the actual audio bandwidth such as 44.1 kHz for Compact Disks. More than 1.400 Megabit would be required to represent just one second of stereo music in compact disk quality. By using MPEG audio coding, the original sound data from a compact disk may be shrunk by a factor of 12, without losing sound quality. Factors of 24 and even more still maintain a sound quality that is significantly better than what can be gotten by just reducing the sampling rate and the resolution of the audio samples. Basically, this is realized by perceptual coding techniques addressing the perception of sound waves by the human ear. By exploiting stereo effects and by limiting the audio bandwidth, the coding schemes may achieve an acceptable sound quality at even lower bit-rates. MPEG-1 Layer-3 is the most powerful member of the MPEG audio coding family for a given sound quality level, either it requires the lowest bit-rate or for a given bit-rate it achieves the highest sound quality.

Using MPEG-1 audio, one may achieve a typical data reduction of 1 to 10 to 12 by Layer 3 which corresponds with 128.112 kilobits per second for a stereo signal, still maintaining the original COMPACT DISK sound quality. By exploiting stereo effects and by limiting the audio bandwidth, the coding schemes may achieve an acceptable sound quality at even lower bit-rates. MPEG-1 Layer-3 is the most powerful member of the MPEG audio coding family. For a given sound quality level, it requires the lowest bit-rate—or for a given bit-rate, it achieves the highest sound quality. In listening tests, MPEG Layer-3 impressively proved its superior performance, maintaining the original sound quality at a data reduction of 1:12 (around 64 kbit/s per audio channel). If applications may tolerate a limited bandwidth of around 10 kHz, a reasonable sound quality for stereo signals can be achieved even at a reduction of 1:24.

For the use of low bit-rate audio coding schemes in broadcast applications at bit-rates of 60 kilobit per second per audio channel, the ITU-R recommends MPEG Layer-3. The filter bank used in MPEG Layer-3 is a hybrid filter bank which consists of a poly-phase filter bank and a Modified Discrete Cosine Transform (MDCT). This hybrid form was chosen for reasons of compatibility to its predecessors.

The perceptual model is mainly determining the quality of a given encoder implementation. It uses either a separate filter bank or combines the calculation of energy values for the masking calculations and the main filter bank. The output of the perceptual model consists of values for the masking threshold or the allowed noise for each encoder partition. If the quantization noise can be kept below the masking threshold, then the compression results should be indistinguishable from the original signal. Joint stereo coding takes advantage of the fact that both channels of a stereo channel pair contain far the same information. These stereophonic irrelevancies and redundancies are exploited to reduce the total bit-rate. Joint stereo is used in cases where only low bit-rates are available but stereo signals are desired. A system of two nested iteration loops is the common solution for quantization and coding in a Layer-3 encoder. Quantization is done via a power-law quantizer. In this way, larger values are automatically coded with less accuracy and some noise shaping is already built into the quantization process. The quantized values are coded by Huffman coding. As a specific method for entropy coding, Huffman coding is loss-less. Thus is called noiseless coding because no noise is added to the audio signal. The process to find the optimum gain and scale factors for a given block, bit-rate and output from the perceptual model is usually done by two nested iteration loops in an analysis-by-synthesis way.

The Huffman code tables assign shorter code words to (more frequent) smaller quantized values. If the number of bits resulting from the coding operation exceeds the number of bits available to code a given block of data, this can be corrected by adjusting the global gain to result in a larger quantization step size, leading to smaller quantized values. This operation is repeated with different quantization step sizes until the resulting bit demand for Huffman coding is small enough. The loop is called rate loop because it modifies the overall encoder rate until it is small enough. To shape the quantization noise according to the masking threshold, scale-factors are applied to each scale-factor band. The system starts with a default factor of 1.0 for each band. If the quantization noise in a given band is found to exceed the masking threshold (allowed noise) as supplied by the perceptual model, the scale-factor for this band is adjusted to reduce the quantization noise. Since achieving a smaller quantization noise requires a larger number of quantization steps and thus a higher bit rate, the rate adjustment loop has to be repeated every time new scale factors are used. In other words, the rate loop is nested within the noise control loop. The outer noise control loop is executed until the actual noise, which is computed from the difference of the original spectral values minus the quantized spectral values, is below the masking threshold for every scale-factor band. There is often a lot of confusion surrounding the terms audio compression, audio encoding, and audio decoding. Up to the advent of audio compression, high-quality digital audio data took a lot of hard disk space to store or channel band-with to transmit. Let us go through a short example. A user wants to sample his favorite 1-minute song and stores it on his hard disk. Because he wants compact disk quality, the samples at 44.1 kHz, stereo, with 16 bits per sample, using 44.100 Hz means that he has 44.100 values per second coming in from either the sound card or the input file, multiplying that by two because there are two channels, multiplying by another factor of two because there are two bytes per value (that's what 16 bit means). The song will take up 44.100 samples per second times 2 channels times 2 bytes per sample times 60 seconds per minute which equals around 10 Megabytes of storage space on a hard disk. If the user wanted to download that over the internet, given an average 28.8 modem, it would take 10.000.000 bytes times 8 bits/byte/times 28.800 bits per second times 60 seconds per minute which equals around 49 minutes in order to download one minute of stereo music. Digital audio coding, which is synonymously called digital audio compression, is the art of minimizing storage space (or channel bandwidth) requirements for audio data. Modern perceptual audio coding techniques exploit the properties of the human ear, the perception of sound, to achieve a size reduction by a factor of 12 with little or no perceptible loss of quality. Therefore, such schemes are the key technology for high quality low bit-rate applications, like soundtracks for CD-ROM games, solid-state sound memories, Internet audio, digital audio broadcasting systems, and the like. The end result after encoding and decoding is not the same sound file anymore as all superfluous information has been squeezed out. This superfluous information is the redundant and irrelevant parts of the sound signal. The reconstructed WAVE file differs from the original WAVE file, but it will sound the same, more or less, depending on how much compression had been performed on it. Because compression ratio is a somewhat unwieldy measure, experts use the term bit-rate when speaking of the strength of compression. Bit-rate denotes the average number of bits that one second of audio data will consume. The usually units here are kbps, 1000 bits per second. For a digital audio signal from a compact disk, the bit-rate is 1411.2 kbps. With MPEG-2 AAC, compact disk-like sound quality is achieved at 96 kbps.

Audio compression really consists of two parts. The first part, called encoding, transforms the digital audio data that resides, say, in a WAVE file, into a highly compressed form called bit-stream (or coded audio data). To play the bit-stream on your soundcard, you need the second part, called decoding. Decoding takes the bit-stream and reconstructs it to a WAVE file. Highest coding efficiency is achieved with algorithms exploiting signal redundancies and irrelevancies in the frequency domain based on a model of the human auditory system.

All encoders use the same basic structure. The encoding scheme can be described as “perceptual noise shaping” or “perceptual sub-band/transform coding”. The encoder analyzes the spectral components of the audio signal by calculating a filter-bank (transform) and applies a psycho-acoustics model to estimate the just noticeable noise-level. In its quantization and coding stage, the encoder tries to allocate the available number of data bits in a way to meet both the bit-rate and masking requirements. The decoder is much less complex. Its only task is to synthesize an audio signal out of the coded spectral components. The term psycho-acoustics describes the characteristics of the human auditory system on which modern audio coding technology is based. The sensitivity of the human auditory systems for audio signals is one of its most significant characteristics. It varies in the frequency domain. The sensitivity of the human auditory system is high for frequencies between 2.5 and 5 kHz and decreases beyond and below this frequency band. The sensitivity is represented by the Threshold In Quiet. Any tone below this threshold will not be perceived. The most important psycho-acoustics fact is the masking effect of spectral sound elements in an audio signal like tones and noise. For every tone in the audio signal a masking threshold can be calculated. If another tone lies below this masking threshold, it will be masked by the louder tone and remains inaudible, too. These inaudible elements of an audio signal are irrelevant for the human perception and thus can be eliminated by the encoder.

For the audio quality of a coded and decoded audio signal the quality of the psycho-acoustics model used by an audio encoder is of prime importance. The audio coding schemes developed by Fraunhofer engineers belong to the best worldwide.

U.S. Pat. No. 5,579,430 teaches a digital encoding process for transmitting and/or storing acoustical signals and, in particular, music signals, in which scanned values of the acoustical signal are transformed by means of a transformation or a filter bank into a sequence of second scanned values, which reproduce the spectral composition of the acoustical signal, and the sequence of second scanned values is quantized in accordance with the requirements with varying precision and is partially or entirely encoded by an optimum encoder, and in which a corresponding decoding and inverse transformation takes place during the reproduction. An encoder is utilized in a manner in which the occurrence probability of the quantized spectral coefficient is correlated to the length of the code in such a way that the more frequently the spectral coefficient occurs, the shorter the code word. A code word and, if needed, a supplementary code is allocated to several elements of the sequence or to a value range in order to reduce the size of the table of the encoder. A portion of the code words of variable length are arranged in a raster, and the remaining code words are distributed in the gaps still left so that the beginning of a code word can be more easily found without completely decoding or in the event of faulty transmission.

U.S. Pat. No. 5,848,391 teaches a method of encoding time-discrete audio signals which includes the steps of weighting the time-discrete audio signal by means of window functions overlapping each other so as to form blocks, the window functions producing blocks of a first length for signals varying weakly with time and blocks of a second length for signals varying strongly with time. A start window sequence is selected for the transition from windowing with blocks of the first length to windowing with blocks of the second length, whereas a stop window sequence is selected for the opposite transition. The start window sequence is selected from at least two different start window sequences having different lengths, whereas the stop window sequence is selected from at least two different stop window sequences having different lengths. A method of decoding blocks of encoded audio signals selects a suitable inverse transformation as well as a suitable synthesis window as a reaction to side information associated with each block.

U.S. Pat. No. 5,812,672 teaches a method for reducing data during the transmission and/or storage of the digital signals of several dependent channels in which the dependence of the signals in the channels, e.g. in a left and a right stereo channel, can be used for an additional data reduction. Instead of known methods such as middle/side encoding or the intensity stereo process that lead to perceptible interference in the case of an unfavourable signal composition, the method avoids such interference, in that a common encoding of the channels only takes place if there is an adequate spectral similarity of the signals in the two channels. An additional data reduction can be achieved in that in those frequency ranges where the spectral energy of a channel does not exceed a pre-determinable fraction of the total spectral energy, the associated spectral values are set at zero.

U.S. Pat. No. 5,742,735 teaches a digital adaptive transformation coding method for the transmission and/or storage of audio signals, specifically music signals in which N scanned values of the audio signal are transformed into M spectral coefficients, and the coefficients are split up into frequency groups, quantized and then coded. The quantized maximum value of each frequency group is used to define the coarse variation of the spectrum. The same number of bits is assigned to all values in a frequency group. The bits are assigned to the individual frequency groups as a function of the quantized maximum value present in the particular frequency group. A multi-signal processor system is disclosed which is specifically designed for implementation of this method.

U.S. Pat. No. 6,101,475 teaches in a method for the cascaded coding and decoding of audio data the spectral components of the short-time spectrum associated with a data block are formed for each data block with a certain number of time input data, the coded signal is formed, by quantization and coding, on the basis of the spectral components for this data block and using a psycho-acoustic model to determine the bit distribution for the spectral components, whereupon time output data are obtained by decoding at the end of each codec stage.

U.S. Pat. No. 6,115,689 teaches an encoder/decoder system which includes an encoder and a decoder. The encoder includes a multi-resolution transform processor, such as a modulated lapped transform (MLT) transform processor, a weighting processor, a uniform quantizer, a masking threshold spectrum processor, an entropy encoder, and a communication device, such as a multiplexor (MUX) for multiplexing (combining) signals received from the above components for transmission over a single medium. The decoder includes inverse components of the encoder, such as an inverse multi-resolution transform processor, an inverse weighting processor, an inverse uniform quantizer, an inverse masking threshold spectrum processor, an inverse entropy encoder, and an inverse MUX. The encoder is capable of performing resolution switching, spectral weighting, digital encoding, and parametric modeling.

U.S. Pat. No. 5,890,112 teaches an audio encoding device which includes an analyzing unit for conducting frequency analyses of an input audio signal, a bit weighting unit for generating a weight signal based on an analysis signal, and a filter for converting an input audio signal into a plurality of frequency band signals. The audio encoding device also has a bit allocating unit for generating quantization data from a frequency band signal based on a value of a weight signal, and a frame packing unit for generating compression data from quantization data and outputting the compression data. A frame completion determining unit determines whether weight allocation processing is normally completed or not, and a storage unit stores the last weight signal recognized as having weight allocation processing normally completed. Further, a switching unit supplies the bit allocating unit with a weight signal stored in the storage unit in place of a weight signal generated by the bit weighting unit according to the determination results of the frame completion determining unit. Research and development have been achieved on a server with a storage device for storing a number of files, such as a movie. The server distributes these files upon a demand from a client.

A video server system needs extension due to lack of capacity of server computers, it has been solved by replacing the old ones with a higher performance server computer, or by increasing the number of server computers so that a load of processing is distributed over a plurality of server-computers. The latter way of extending the system by increasing the number of server computers is effective in terms of workload and cost. A video server as such is introduced in “A Tiger of Microsoft, United States, Video on Demand” in an extra volume of Nikkei Electronics titled “Technology which underlies Information Superhighway in the United States”, pages 40, 41 published in Oct. 24, 1994 by Nikkei BP.

A server system includes a network and server-computers. The server-computers are connected to the network and have a function as a video server, magnetic disk unit which are connected to the server computers and stores video programs, clients which are connected to the network and demand the server computers to read out a video program. Each server computer has a different plurality of set of video programs such as a movie stored in the magnetic disk units. A client therefore reads out a video program via one of the server-computers which has a magnetic disk units where a necessary video program is stored. The server system in which each one of a plurality of server-computers stores an independent set of video programs. The server system is utilized efficiently when each demand on a video program is distributed to different server computers. However when a plurality of accesses rush into a certain video program, a work load increases on a server computer where this video program is stored, namely a work load disparity will be caused among server computers. Even if the other server computers remain idle, the whole capacity of the system has reached to the utmost level because of the overload on a capacity of a single computer. This deteriorates the efficiency of the server system.

U.S. Pat. No. 5,630,007 teaches a client-server system which includes a plurality of servers and a plurality of storage devices. The storage devices sequentially store data. The data is distributed in each of the plurality of storage devices. Each server device is connected to the plurality of storage devices for accessing the data distributed and stored in each of the plurality of storage devices. The client-server system improves efficiency of each server by distributing loads to a plurality of servers. The client-server system also includes an administration apparatus. The administration apparatus is connected to the plurality of servers for administrating the data sequentially stored in the plurality of storage devices and the plurality of servers. A client is connected to both the administration apparatus and the plurality of servers. The client specifies a server that is connected to a storage device where a head block of the data is stored by inquiring to the administration apparatus and accesses the data in the plurality of servers according to the order of the data storage sequence from the specified server. The client makes an inquiry to the administration apparatus and accesses the data in the plurality of servers in accordance to the order of the data storage sequence from the specified server.

U.S. Pat. No. 5,905,847 teaches a client-server system which improves efficiency of each server by distributing loads to a plurality of servers having a plurality of storage devices. The storage devices sequentially store data. The data is distributed in each of the plurality of storage devices. Each server is connected to the plurality of storage devices for accessing the data distributed and stored in each of the plurality of storage devices. An administration apparatus is connected to the plurality of servers for administrating the data sequentially stored in the plurality of storage devices and the plurality of servers. A client is connected to both the administration apparatus and the plurality of servers. The client specifies a server which is connected to a storage device in which a head block of the data is stored by making an inquiry to the administration apparatus and accesses the data in the plurality of servers in accordance to the order of the data storage sequence from the specified server.

U.S. Pat. No. 5,926,101 teaches a multi-hop broadcast network of nodes which have a minimum of hardware resources, such as memory and processing power. The network is configured by gathering information concerning which nodes can communicate with each other using flooding with hop counts and parent routing protocols. A partitioned spanning tree is created and node addresses are assigned so that the address of a child node includes as its most significant bits the address of its parent. This allows the address of the node to be used to determine if the node is to process or resend the packet so that the node can make complete packet routing decisions using only its own address.

U.S. Pat. No. 6,108,703 teaches a network-architecture which has a framework. The framework supports hosting and content distribution on a truly global scale. The framework allows a content provider to replicate and serve its most popular content at an unlimited number of points throughout the world. The framework includes a set of servers operating in a distributed manner. The actual content to be served is preferably supported on a set of hosting servers (sometimes referred to as ghost servers). This content includes HTML page objects that are served from a content provider site. A base HTML document portion of a Web page is served from the content provider's site while one or more embedded objects for the page are served from the hosting servers, preferably, those hosting servers near the client machine. By serving the base HTML document from the content provider's site, the content provider maintains control over the content.

U.S. Pat. No. 5,367,698 teaches a networked digital data processing system which has two or more client devices and a network. The network includes a set of inter-connections for transferring information between the client devices. At least one of the client devices has a local data file storage element for locally storing and providing access to digital data files arranged in one or more client file systems. A migration file server includes a migration storage element that stores data portions of files from the client devices, a storage level detection element that detects a storage utilization level in the storage element, and a level-responsive transfer element that selectively transfers data portions of files from the client device to the storage element.

U.S. Pat. No. 5,802,301 teaches a method for improving load balancing in a file server. The method includes the steps of determining the existence of an overload condition on a storage device having a plurality of retrieval streams, accessing at least one file thereon, selecting a first retrieval stream reading a file, replicating a portion of the file being read by the first retrieval stream onto a second storage device and reading the replicated portion of the file on the second storage device with a retrieval stream capable of accessing the replicated portion of the file. The method enables the dynamic replication of data objects to respond to fluctuating user demand. The method is particularly useful in file servers such as multimedia servers delivering continuously in real time large multimedia files such as movies.

U.S. Pat. No. 5,542,087 teaches a data processing method which generate a correct memory address from a character or digit string such as a record key value and which is adapted for use in distributed or parallel processing architectures such as computer networks, multiprocessing systems, and the like. The data processing method provides a plurality of client data processors and a plurality of file servers. Each server includes at least a respective one memory location or “bucket”. The data processing method includes the steps of generating a key value by means of any one of the client data processors and generating a first memory address from the key value. The first address identifies a first memory location. The data processing method also includes the steps of selecting from the plurality of servers a server that includes the first memory location, transmitting the key value from the one client to the server that includes the first memory location and determining whether the first address is the correct address by means of the server. The data processing method further provides that if the first address is not the correct address then performing the steps of generating a second memory address from the key value by means of the server, the second address identifying a second memory location, selecting from the plurality of servers another server which includes the second memory location, transmitting the key value from the server that includes the first memory location to the other server which includes the second memory location, determining whether the second address is the correct address by means of the other server and generating a third memory address, which is the correct address, if neither the first or second addresses is the correct address. The data processing method provides fast storage and subsequent searching and retrieval of data records in data processing applications such as database applications.

Distributed storage and sharing of data and program files has become an integral part of doing business over the Internet and other distributed networks. Such a distributed environment is characterized by the fact that multiple copies of the same file reside over the network.

In peer-to-peer networking each user also doubles as a server connected to the Internet. Service providers, such as Napster, Gnutella and Freenet have emerged. This emerging technology has the potential to revolutionize Internet and E-Commerce, but several technological challenges have to be overcome before it can be translated into a robust product which hundreds of millions of customers can reliably use.

The most frequent use of such a network is for downloading purposes. A client looks up the content list, and wants to download a particular file/content from the network. The existing protocols for this process are extremely simple and can be described in general as follows. The client or a central server searches the list of servers that contain the desired file, and picks one such server (either randomly or according to some priority list maintained by the central server) and establishes a direct connection between the client requesting the down load and the chosen server. This connection is maintained until the entire file has been transferred. The exact implementation might vary from one protocol to another; however, the fact that only one server is picked for the transfer of the entire requested file remains invariant.

The above-mentioned existing protocols suffer from several serious drawbacks, as stated next. Since only one server is picked for the transfer of the entire file (even though there are potentially many servers with the same content), the quality of service becomes totally dependent on the bandwidth and the reliability of the Internet access that the chosen server maintains during the transfer. This poses a serious problem, especially in the case of networks that primarily comprise of low-performance servers as is the case for Napster and other proposed peer-to-peer networks and the reliability and speed of the host computers cannot be guaranteed. The average available bandwidth could be as low as that of a 28.8K or a 56K modem. Moreover, the connection of the server to the Internet could be dropped in the middle of a download, necessitating another attempt from the beginning. For example, an average MP3 file is around 5 Mega-bytes in length, and it will take around 16-20 minutes to download it over a 56K modem!! If the connection is dropped at any time during this period, then one needs to attempt the download all over again. The issue of choosing the best server among those that have a copy of the requested file is not properly addressed, leading to a further loss in the quality of the service. If the winner is picked randomly then clearly it is not the best choice. Even if the winner is picked based on a pre-sorted list, where servers are ranked according to their average available bandwidth, the resulting scheme would be far from optimal. In particular, even if a server has a higher average bandwidth, since it comprises only a part of the host computer and shares the bandwidth with other competing tasks, the available bandwidth for the download could be drastically low during the time of the transfer. The protocols do not take advantage of the fact that the client could have a much higher available bandwidth than any of the potential servers. For example, even if the client is connected to a high-speed Ethernet, the effective transfer rate for the session could still be as low as that of a modem that the chosen server might be using. Accuracy and integrity of the downloaded file are not usually guaranteed. Since multiple copies of files are maintained by different servers the issue of the integrity of the downloaded files becomes a serious concern.

The inventor incorporates the teachings of the above-cited patents into this specification.

### SUMMARY OF THE INVENTION

The present invention is directed to a system for transmitting a digital signal. The system includes an encoder for band-compression coding a digital signal as encoded data defining an image and a transmitter. The transmitter transmits the encoded data.

In a first separate aspect of the present invention the system for transmitting a digital signal also includes a perceptual encryption system which is coupled to the encoder. The perceptual encrypting system perceptually encrypts the encoded data to generate restricted video data as perceptually encrypted encoded data.

In a second separate aspect of the present invention a combined receiver and decoder for a restricted video data as perceptually encrypted encoded data includes a receiver and a decoder. The receiver receives the perceptually encrypted encoded data. The decoder decodes the perceptually encrypted encoded data to generate low quality video.

In a third separate aspect of the present invention a combined receiver, perceptual decrypting system and decoder for a restricted video data as perceptually encrypted encoded data includes a receiver, a perceptual decrypting system and a decoder. The receiver receives the perceptually encrypted encoded data. The perceptual decrypting system perceptually decrypts the perceptually encrypted encoded data to generate encoded data. The decoder decodes the encoded data to generate low quality video.

Other aspects and many of the attendant advantages will be more readily appreciated as the same becomes better understood by reference to the drawing and the following detailed description.

The features of the present invention which are believed to be novel are set forth with particularity in the appended claims.

### DESCRIPTION OF THE DRAWINGS

FIG. 1 is a schematic drawing of a digital signal transmitting apparatus according to the prior art.

FIG. 2 is a schematic drawing of a digital signal receiving apparatus according to the prior art.

FIG. 3 is a schematic drawing explaining the problems occurring when in the digital signal receiving apparatus of FIG. 2 software information is downloaded.

FIG. 4 is a schematic drawing of a digital signal transmitting apparatus of U.S. Pat. No. 5,721,778.

FIG. 5 is a schematic drawing of a digital signal receiving apparatus of U.S. Pat. No. 5,721,778.

FIG. 6 is a schematic drawing of a sending section of the digital signal transmitting apparatus of FIG. 4.

FIG. 7 is a schematic drawing of a software supply section of the digital signal transmitting apparatus of FIG. 4.

FIG. 8 is a schematic drawing of a distribution system for distributing a file of restricted fidelity audio data as perceptually encrypted encoded data in the MP3 format. The distribution system includes an audio source, an encoder and a first perceptual encryter.

FIG. 9 is a schematic drawing of a frame of a file of high fidelity audio data as encoded data.

FIG. 10 is a schematic drawing of the encoder and the first perceptual encrypter of the distribution system of FIG. 8. The first perceptual encrypter includes a first perceptual encryption module, a fidelity parameter module and a key module.

FIG. 11 is a schematic drawing of an unpacked frame of the file of high fidelity audio data as encoded data in the MP3 format of FIG. 9.

FIG. 12 is a schematic drawing of the first perceptual encryption module, the fidelity parameter module and the key module of FIG. 10.

FIG. 13 is a schematic drawing of an unpacked frame of a file of restricted audio data as perceptually encrypted encoded data when the cut-off frequency less than the highest big-value frequency.

FIG. 14 is a schematic drawing of an unpacked frame of a file of restricted audio data as perceptually encrypted encoded data when the cut-off frequency is greater than the highest big-value frequency.

FIG. 15 is a schematic drawing of a first receiving system. The first receiving system includes a receiver/ storage device, a decoder and a player.

FIG. 16 is a schematic drawing of the decoder of the first receiving system of FIG. 17.

FIG. 17 is a schematic drawing of a second receiving system. The second receiving system includes a receiver/storage device, a first perceptual decrypter, a decoder and a player.

FIG. 18 is a schematic drawing of the first perceptual decrypter and the decoder of the second receiving system of FIG. 10. The first perceptual decrypter includes a first perceptual decryption module and a key receiving module.

FIG. 19 is a schematic drawing of the first perceptual decryption module of FIG. 16.

FIG. 20 a schematic drawing of a second distribution system for distributing a file of restricted fidelity audio data as twice-perceptually encrypted encoded data in the MP3 format. The second distribution system includes an audio source, an encoder, a second perceptual encryter and a server.

FIG. 21 is a schematic drawing of the encoder and the second perceptual encrypter of the second distribution system of FIG. 13. The second perceptual encrypter includes a second perceptual encryption module, a fidelity parameter module and a key module.

FIG. 22 is a schematic drawing of the second perceptual encryption module, the fidelity parameter module and the key module of FIG. 14.

FIG. 23 is a schematic drawing of an unpacked frame of a file of restricted audio data as twice-perceptually encrypted encoded data.

FIG. 24 is a schematic drawing of a third receiving system which includes a receiver/storage device, a second perceptual decrypter, a decoder and a player.

FIG. 25 is a schematic drawing of the second perceptual decrypter and the decoder of the third receiving system of FIG. 17. The second perceptual decrypter includes a second perceptual decryption module, a first key receiving module for receiving a first key and a second key receiving module for receiving a second key.

FIG. 26 is a schematic drawing of the second perceptual decryption module and the first and second key receiving modules of FIG. 25 when only the first key has been received.

FIG. 27 is a schematic drawing of an unpacked frame of a file of intermediate fidelity audio data as once-perceptually decrypted, twice-perceptually encrypted encoded data. The second perceptual decryption module of FIG. 26 generated the file of intermediate fidelity audio data.

FIG. 28 is a schematic drawing of the second perceptual decryption module and the first and second key receiving modules of FIG. 25 when both the first key and second key have been received.

FIG. 29 is a schematic drawing of an unpacked frame of a file of high fidelity audio data as twice-perceptually decrypted, twice-perceptually encrypted encoded data in the MP3 format. The second perceptual decryption module of FIG. 28 generated the file of high fidelity audio data.

FIG. 30 is a schematic diagram of a video server system of the prior art.

FIG. 31 is a schematic diagram of a video server system of U.S. Pat. No. 5,630,007.

FIG. 32 is a schematic diagram of an administration table according to U.S. Pat. No. 5,630,007.

FIG. 33 is a schematic drawing a distributed network having a plurality of hosts. Each host acts as both a client and a server.

FIG. 34 is a schematic drawing of a file format for use in the distributed network of FIG. 33.

FIG. 35 is a schematic drawing of an entry for a file in a global list in which the entry contains all the necessary information about the file so that a client can successfully complete an incasting process using the distributed network of FIG. 33.

FIG. 36 is a schematic drawing of the architecture of an MPEG-1 program undergoing perceptual encryption to generate a perceptually encrypted MPEG-1 stream.

FIG. 37 is a schematic drawing of a diagram showing an original video packet containing high fidelity video being transformed into a new video packet containing low-fidelity video data and an ancillary data containing encrypted refinement data of FIG. 36 using an encryption module.

FIG. 38 is a schematic drawing of a diagram showing sequences of luminance and chrominance blocks in the 4:2:0 video format which are used in MPEG-1.

FIG. 39 is a schematic drawing of flow chart of the DCT of the 8×8 block coefficients of the original video packet of FIG. 37.

FIG. 40 is a schematic diagram of the 8×8 block coefficients of the original video packet of FIG. 37 which are divided into the low-fidelity video data and the ancillary data.

FIG. 41 is a block diagram of perceptual encryption.

FIG. 42 is a schematic drawing of a standard MPEG-1 player which plays the perceptually encrypted MPEG-1 stream of FIG. 36 as low fidelity video.

FIG. 43 is a schematic drawing of a standard MPEG-1 player which has a decryption module which with the use of the key of FIG. 37 plays the perceptually encrypted MPEG-1 stream of FIG. 36 as high fidelity video.

FIG. 44 is a block diagram of perceptual decryption.

FIG. 45 is a schematic diagram of an audio-on-demand system.

FIG. 46 is a schematic drawing of the audio-on-demand system of FIG. 45 including a distributing system according to the first embodiment. The distributing system includes an encoder and a perceptual encryter.

FIG. 47 is a schematic drawing of a digital signal transmitting apparatus according to the second embodiment.

FIG. 48 is a schematic drawing of a digital signal receiving apparatus according to the third embodiment.

### DESCRIPTION OF THE PREFERRED EMBODIMENT

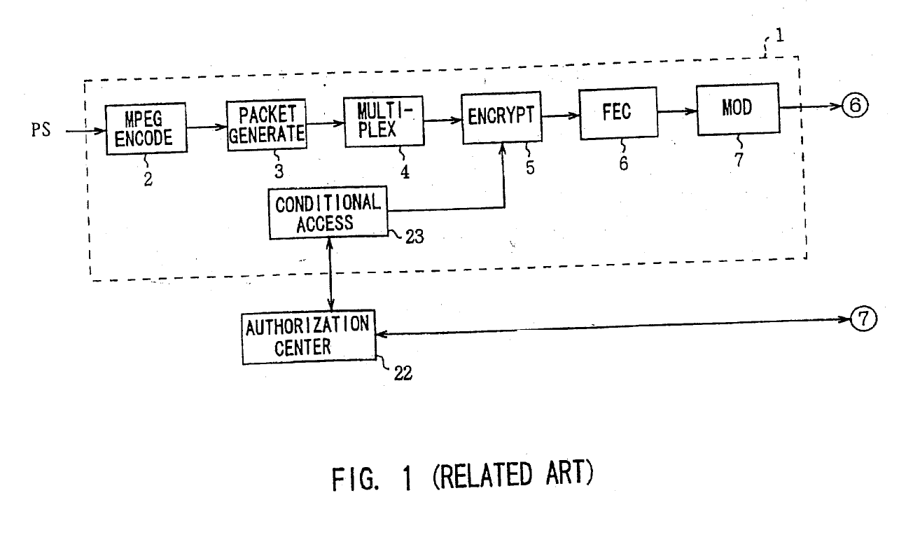

Referring to FIG. 1 a prior art digital signal transmitting system uses satellites or cables. A program source PS, input to a digital signal transmitting apparatus, such as a broadcasting station 1, is band-compression coded with a moving picture image coding expert group (MPEG) method by means of an MPEG encoder 2. The input is converted to packet transmission data by means of a packet generation section 3. The packetized transmission data is multiplexed by a multiplexer 4, then the transmission data is scrambled for security by an encryption processing section 5, and finally keys (ciphers) are put over the scrambled data many times so that the scrambling cannot be descrambled easily. The encrypted transmission data is error corrected by a forward error correction (FEC) section 6 and modulated by a modulator 7.

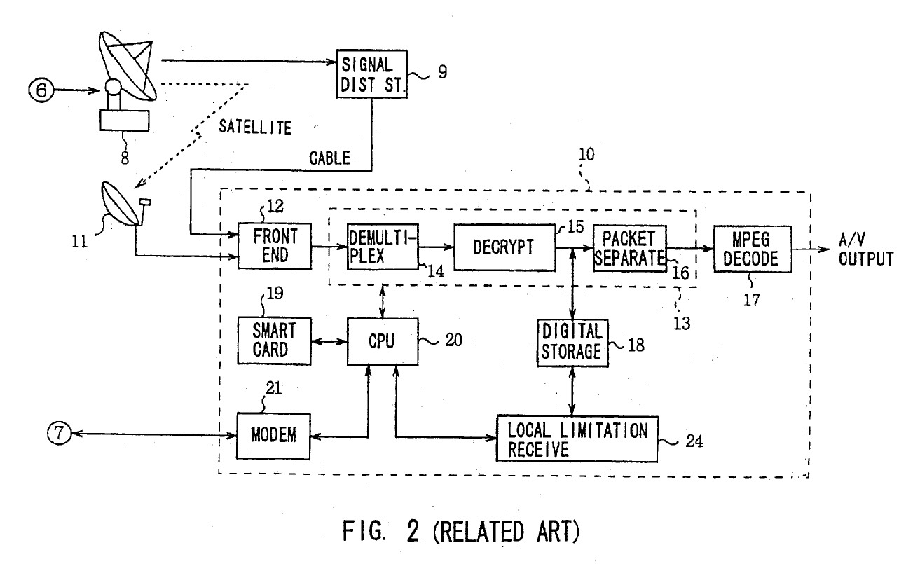

Referring to FIG. 2 in conjunction with FIG. 1 the modulated data is then sent through a digital satellite 8 directly to a digital signal receiving apparatus installed in a contract user's household, i.e., a terminal 10, or sent through the digital satellite 8 to a signal distributing station 9 which is called a head end. The data, transmitted to the signal distributing station 9, is sent to the terminal 10 via cable. In the terminal 10, when the transmission data is directly sent via the satellite 8, the data is received by an antenna 11 and sent to a front end section 12. When the transmission data is sent from the signal distributing station 9 via the cable, it is inputted directly to the front end section 12. A user contracts with the broadcasting station 1 and accesses a key which is authorized to each user to the terminal 10, with respect to the transmission data sent directly from the satellite 8 or from the satellite 8 via the signal distributing station 9, so that the user is authorized as a contract user and bill processing is performed, and at the same time, the user can appreciate desired software information. In the terminal 10 the transmission data is processed by the front end section 12 which includes a tuner, a demodulator and an error corrector. The processed data is input to a data fetch section 13. In the data fetch section 13, the multiplexed data is demultiplexed by the demultiplexer 14. The data is separated into a video signal, an audio signal, and data other than these signals. In a decryption section 15, ciphers are decrypted while performing bill processing. In a packet separation section 16, the decrypted data is packet separated. Compression of the data is expanded by an MPEG decoder 17. The video and audio signals are digital-to-analog converted to analog signals and are outputs to a television. When fee-charged software information, such as video on demand or near video on demand is transmitted, a digital storage 18 such as tape media or disk media is incorporated into or connected to the terminal 10 to meet the convenience of users and to effectively utilize a digital transmission path. Large amounts of software data have been downloaded to the storage 18 by making use of an unoccupied time band and an unoccupied transmission path. When the user looks at the software information at hand, the user accesses it with a smart card to perform bill processing, and reproduction limitation is lifted. If the user accesses a central processing unit by means of the smart card 19 and a modem 21. The CPU 20 performs an inquiry of registration to an authorization center 22 through the modem 21. The authorization center 22 confirms registration by means of a conditional access 23. If registration is confirmed, the authorization center 22 performs bill processing and also performs notification of confirmation to the CPU 20 through the modem 21. The CPU 20 sends the decryption key to a local conditional access 24 by this notification. The local conditional access 24 decrypts a cipher which has been put over the data recorded on the storage 18. The reproduction limitation is lifted and the packet of the data recorded on the storage 18 is separated by the packet separation section 16. The compression of the packet-separated data is decompressed (expanded) by the MPEG decoder 17 and then the expanded data is digital-to-analog converted to be output to television as the analog signal and audio signal A/V. If, in the security system in a current broadcasting form, software information has been downloaded to the storage 18 to try to realize a system where this software can be appreciated when user wants to see it, then the following problems will arise.

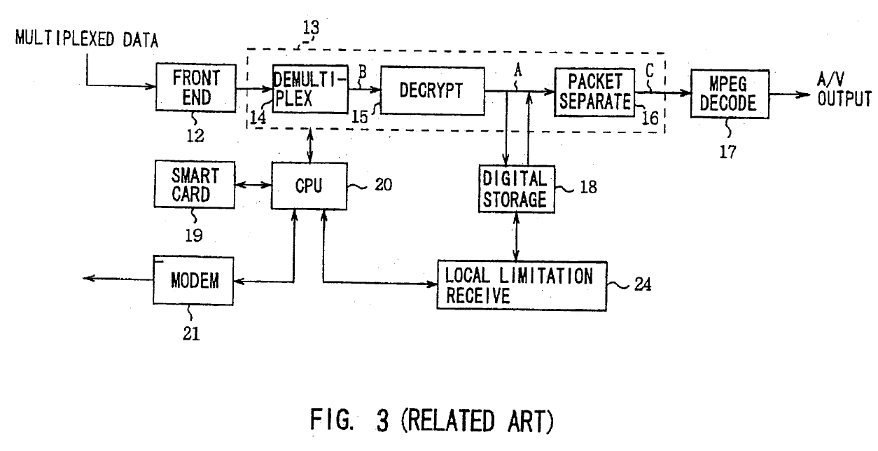

Referring to FIG. 3 when in the current digital signal transmitting system a cipher is decrypted by the decrypting section 15 software information is downloaded to the storage 18, as shown by point A, and the fee-charged software cannot be downloaded to the storage 18 by decrypting the cipher without billing, because decrypting a cipher is, vis-a-vis, billing. Now, if only billing information is made free, all ciphers of data are decrypted and downloaded to the storage 18, then a piece of software information is passed as it is and output from the terminal 10. The storage 18 is not incorporated into the terminal 10 but is connected to the terminal 10. Switching means is not provided between the decryption section 15. The packet separation section 16, if ciphers are all decrypted and downloaded to the storage 18, the decrypted data are all sent and there is the possibility that they can been seen for free at point C by persons other than contract users. To solve these problems, data can be downloaded to the storage 18 before ciphers are decrypted, after multiplex is demultiplexed by the demultiplexer 14 (point B). If data are downloaded to the storage 18 after multiplex is demultiplexed by the demultiplexer 14, there is the problem that intra-coded (I) pictures can not be pulled out and can not be reproduced at variable speed, because data remain encrypted. In broadcasting systems keys are changed annually or biennially to ensure security. When a key is changed after software information is downloaded to the storage 18, there is the problem that ciphers cannot be decrypted and therefore the downloaded software information cannot be seen.

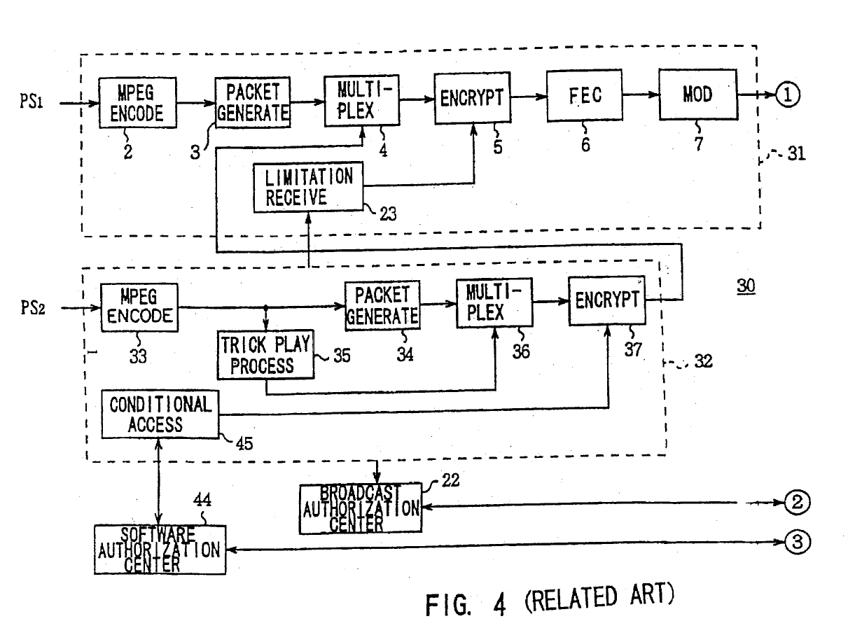

Referring to FIG. 4 the same reference numerals are applied to corresponding parts with FIG. 1, reference numeral 30 denotes a digital signal transmitting apparatus of U.S. Pat. No. 5,721,778. In the digital signal transmitting apparatus 30, such as a broadcasting station, when predetermined services, such as fee-charged software data, are transmitted, twofold security is ensured by putting a cipher of a storage system over software data and further putting a cipher of a broadcasting system over the software data. The digital signal transmitting apparatus 30 is constituted by a digital signal sending section 31 and a software supply section 32. In the digital signal transmitting apparatus 30, when fee-charged software information, for example, image software, music software, electronic program list, shopping information, game software, or education information is requested by users, the software information as a program source PS.sub.2 is input to the software supply section 32. In the software supply section 32, the software data PS.sub.2 comprising a digital signal is band-compression coded by means of an MPEG encoder 33. The band-compression coded digital signal is input to a packet generation section 34 and a trick play processing section 35. In the trick play processing section 35, variable-speed reproduction processing, i.e., processing for extracting an intra-coded (I) picture is performed for the video data. The extracted I picture is output to a multiplexer 36. A technique for variable-speed reproducing an image which has been band-compression coded by an MPEG method disclosed in Japanese Patent Application No. 287702/1993. In the packet generation section 34, the input digital signal is packetized to video data, audio data, and other data. These packetized data are multiplexed by a multiplexer 36. In the multiplexer 36, an I picture is buried in the video data. A cipher of a storage system is put over the multiplexed digital signal by an encryption processing section 37, and the encrypted signal is sent to a multiplexer 4 of a rear sending section 31. In the multiplexer 4, digital signals over which the ciphers of storage system were put are multiplexed. In an encryption processing section 5, a cipher of a broadcasting system is put over this multiplexed digital signal. A cipher of a storage system and a cipher of a broadcasting system are put over the digital signal sent from the digital signal transmitting apparatus 30 in duplicate. In the sending section 31, key data that are added to programs are all common and broadcasting billing data is free of charge. This double security added digital signal is sent to a terminal installed in a household, i.e., a digital signal receiving apparatus 40 directly from a satellite 8 or by way of a signal distributing station 9 from the satellite 8.

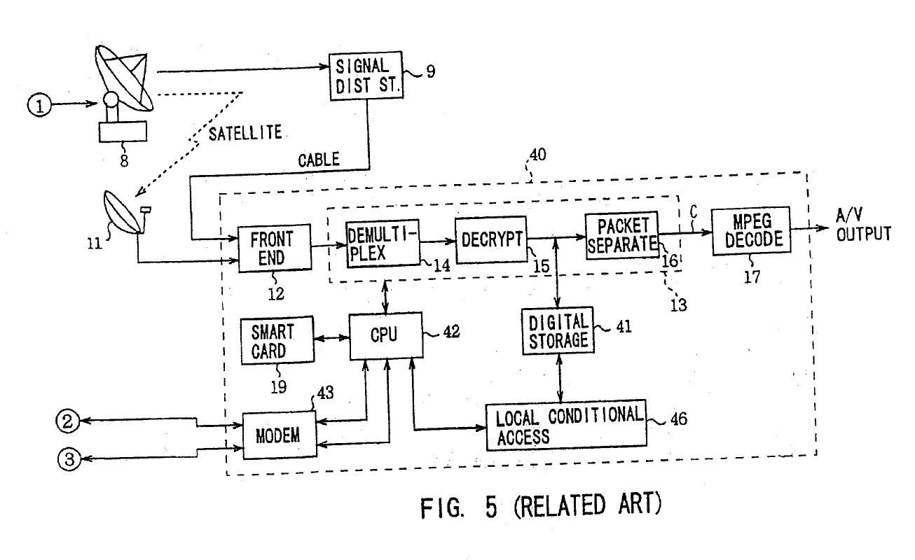

Referring to FIG. 5 the same reference numerals are applied to corresponding parts with FIG. 2. In the digital signal receiving apparatus 40 of U.S. Pat. No. 5,721,778 the cipher of the broadcasting system, put over the transmitted digital signal, is decrypted by accessing the smart card 19, and the digital signal can be downloaded to a digital storage 41. The cipher of the broadcasting system of the transmitted digital signal is decrypted by the decrypting section 15. The digital signal is recorded on the digital storage 41. In this case, the digital signal which is downloaded to the digital storage 41 is recorded in the state where only the cipher of the storage system has been put over and also recorded in the state where variable-speed reproduction processing has been performed. Therefore, even if the key of the broadcasting system, added by the sending section 31, were changed, there would be no influence. No image is viewed free of cost because the cipher of the storage system has been put over at point C. When a user desires to see the software information PS.sub.2 downloaded to the storage 41, a CPU 42 performs an inquiry of registration to an authorization center 44 for software information through a modem 43, by inputting an ID number registered independently of the broadcasting system (for example, on the screen of a personal computer, put an ID number). The CPU 42 usually performs an inquiry of registration to a broadcasting-system authorization center 22 for the contract program PS.sub.1 and performs an inquiry of registration to the software-system authorization center 44 for the software information PS.sub.2. That is, the CPU 42 constructs two independent billing systems, a billing system for a broadcasting system and a billing system for a software system, by controlling the share of the modem 43.

The authorization center 44 sends the ID number to the conditional access 45 of the software supply section 32 and confirms registration. If the authorization center 44 confirms registration, bill processing is performed and the CPU 42 instructs a local conditional access 46 to decrypt a cipher. The local conditional access 46 has a function of decrypting the cipher of the software system. The reproduction limitation of the storage 41 is lifted and the cipher is decrypted, so that the user is able to see software information by the same manipulation as a normal video tape recorder.

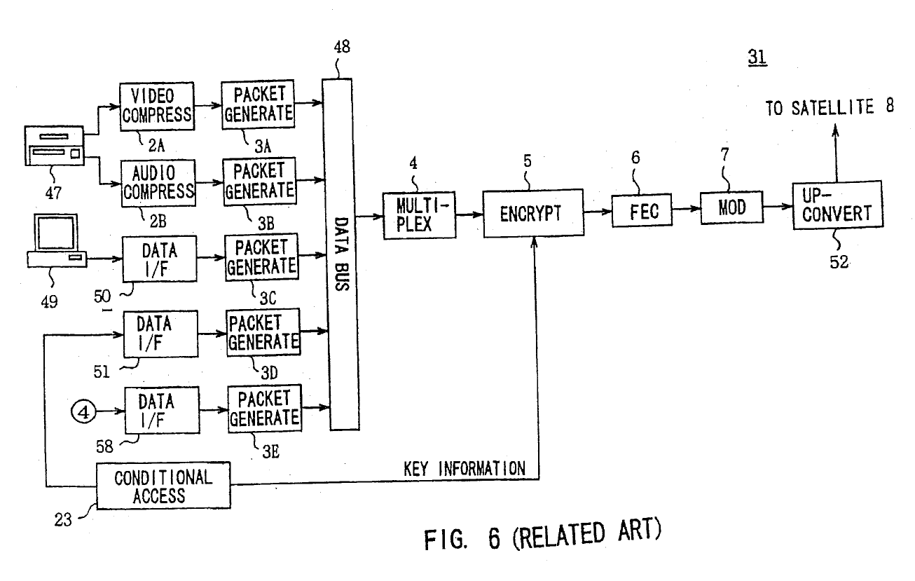

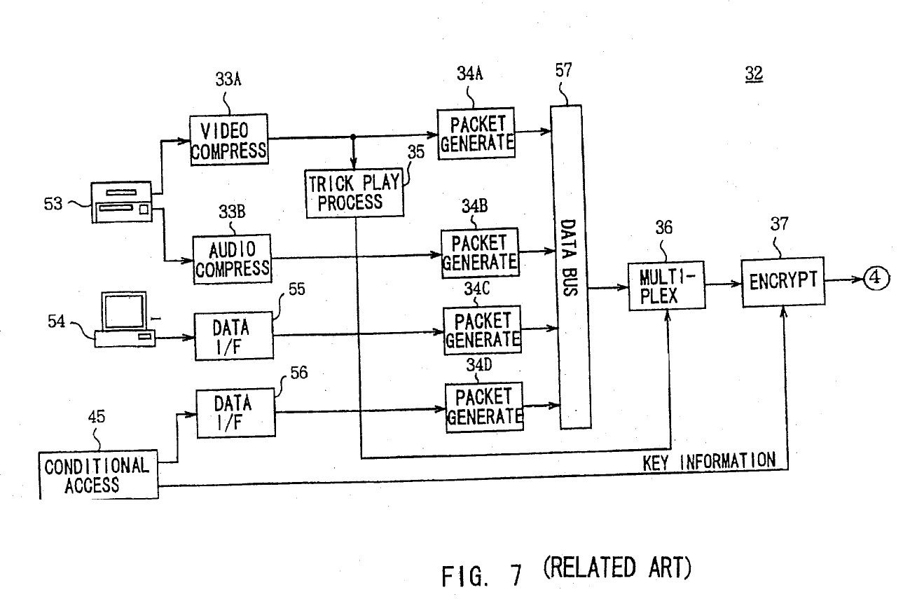

Referring to FIG. 6 in conjunction with FIG. 7 in the digital signal transmitting apparatus 30, when a normal contract program PS.sub.1 is supplied, the program source PS.sub.1 is input directly to the sending section 31, and when fee-charged software information PS.sub.2 is supplied, the fee-charged software information PS.sub.2 is supplied to the sending section 31 through the software supply section 32. For the appreciation of the program PS.sub.1, the video signal and the audio signal of a program, which is supplied, for example, from a digital VTR 47, are band-compression coded by means of MPEG encoders 2A and 2B and then are packetized for each video data and for each audio data by means of packet Generation sections 3A and 3B. The packetized video data and audio data are sent to a multiplexer 4 via a data bus 48. At the same time as this, for example, a personal computer 49 sends data other than video data and audio data to a packet generation section 3C through a data interface (data I/F) 50 to be packetized. The packetized data from the packet generation section 3C is then sent through the data bus 48 to the multiplexer 4. Also, a conditional access 23 sends key data through a data I/F 51 to a packet generation section 3D to packetize it, and the packet key data from the packet generation section 3D is sent through the data bus 48 to the multiplexer 4. The conditional access 23 further sends key information for encrypting software data to an encryption processing section 5. In the multiplexer 4, the video data, the audio data, and other data are multiplexed. The encryption processing section 5 puts a cipher over this multiplexed data, based on the key information input from the conditional access 23. The encrypted data is error corrected by a FEC section 6. The error-corrected data is modulated by a modulator 7 and then transmitted to a satellite 8 via an up-converter 52. When, on the other hand, fee-charged software information PS.sub.2 is transmitted, the video signal and the audio signal of the software information PS.sub.2 which is output, for example, from a digital VTR 53 are band-compression coded by means of MPEG encoders 33A and 33B, respectively. The band-compression coded video signal is input to a packet generation section 34A and a trick play processing section 35. The packet generation section 34A packetizes the input video signal. The trick play processing section 35 extracts an I picture from the input video signal and then outputs the I picture to a multiplexer 36. The band-compression coded audio signal is input to a packet Generation section 34B, which packetizes the audio signal. General data other than video data and audio data, input from the PC 54, is input through a data I/F 55 to a packet generation section 34C. In addition, the conditional access 45 sends key data to a packet generation section 34D through a data I/F 56 and also sends key information for storage system to the encryption processing section 37. The packetized data from the packet generation sections 34A to 34D are multiplexed by the multiplexer 36 through the data bus 57 and the I picture is buried in video data. An encryption processing section 37 encrypts the multiplexed data, based on the key information input from the conditional access 45, and outputs the encrypted data to the packet generation section 3E of the sending section 31 through a data I/F 58. The packetized data from the packet generation section 3E is sent through the data bus 48 to the multiplexer 4 to be multiplexed, and then sent to the encryption processing section 5. In the encryption processing section 5, a cipher of the boadcasting system is put over the multiplexed data. The encrypted data is processed by the FEC section 6, the modulator 7 and the up-converter 52. The processed data is transmitted to the terminal 40 directly from the satellite 8 or by way of the signal distributing station 9 from the satellite 8.

Referring to FIG. 8 a first distribution system 110 includes an audio source 111 and an encoder 112. The audio source 111 may be a compact disk and a player and provides a high fidelity audio signal. In the general case the encoder 112 encodes the high fidelity audio signal and generates a file of high fidelity audio data as encoded data in a lossy algorithm format. The lossy algorithm format may be any one of the following lossy algorithms: Advanced Audio Coding, MPEG Audio Layer 3 and TwinVQ. MPEG Audio Layer 3 (hereafter referred to as “MP3”) and MPEG Advanced Audio Coding 3 (hereafter referred to as “AAC) are shaping up as the preferred form of distributing and storing music via the Internet. In general the bit rate of 128 kbps is used at present. These two algorithms along with Twin VQ (Yamaha's Sound VQ) all work by breaking the sound into short time segments, filtering those segments into separate frequency bands, encoding the signal in each frequency band and then by using a mathematical model of human hearing sending the most audible parts of the signal to the output stream. With enough bits in the output stream, the result may be lossless in that the decoded file is bit-for-bit identical with the original. The Fraunhofer Institute for Integrated Circuits IIS-A is the home of the MP3 format. The MP3 compression algorithm is documented at http://www.iis.fhg.de/amm/techinf/layer-3. The AAC compression algorithm is documented at http://mp3tech.cjb.net. Twin VQ compression algorithm is documented at http://www.yamahaxg.com/english/xg/SoundVQ/index.html.

Still referring to FIG. 8 the first distribution system 110 also includes a first perceptual encrytper 113 and a server 114. The first perceptual encrypter 113 perceptually encrypts the file of high fidelity audio data as encoded data in the lossy algorithm format in order to generate a file of restricted fidelity audio data as perceptually encrypted encoded data in the lossy algorithm format. The server 114 either stores in a memory bank or distributes from the memory bank the file of restricted fidelity audio data as perceptually encrypted encoded data in the lossy algorithm format.

Referring to FIG. 8 in conjunction with FIG. 9 in a specific case the encoder 112 encodes the high fidelity audio signal and generates a file 120 of high fidelity audio data as encoded data in the MP3 format. The first perceptual encrypter 13 perceptually encrypts the file 120 of high fidelity audio data as encoded data in the MP3 format and generates a file 130 of restricted fidelity audio data as perceptually encrypted encoded data in the MP3 format. The server 114 either stores in a memory bank or distributes from the memory bank the file of restricted fidelity audio data as perceptually encrypted encoded data in the MP3 format.

Referring to FIG. 9 the file 120 of high fidelity audio data as encoded data in the MP3 format has a plurality of frames 121. Each frame 121 has a header 122 with a sync 123 and side information 124 and main information 125.

The MPEG-1, Layer 3 (MP3) Standard is a very flexible scheme for perceptually encoding audio data. Perceptual encoding only encodes the portion of the audio data that is likely to be perceived by the human listener. Perceptual encoding can compress audio data by a factor of ten as compared to the size of compact disk audio files.

In simplified terms the MP3 Standard requires that the audio data in the time domain be segmented into sets of 576 frequency samples with each set of 576 samples representing 13.5 milliseconds of audio. A Fourier transform is computed to give 576 frequency samples, which is called a granule. In each frame, there are two granules. For each granule of 576 frequency samples there are various techniques which are used to reduce the amount of data to describe the 576 frequency samples. There are three sections in this set of 576 frequency samples: a big value section, a small value section and a zero value section. The zero value section contains the coefficients for the highest frequencies. These coefficients are all zero. The small value section contains the coefficients for the middle frequencies. These coefficients have a value −1, 0 or 1. The small value section is disposed between the zero value section and the big value section. The big value section contains the coefficients of the lowest frequencies. These coefficients may be of any magnitude. In practice, either all of the audio data may be in the big value section or in both the big value section and the small value section. The frequency range of the big value section and the total size in bits of both the big values and the small values are given in the side information. The total size in bits of both the big values and the small values is stored according to the variable part 2.3 of the MP3 standard. This allows one to infer the number of lines in the small value section. Since the total number of samples is 576, one can infer the number of samples in the zero value section. The zero values are not encoded in the file 20. The bit-rate of an MP3 file points the way to find the next header and does not affect quality except to set the average bit-rate of the file. In addition to the header, side information, scale factors and Huffman code bits, there are ancillary bits. These ancillary bits are ignored by decoders and exist between the end of the Huffman code bits and the beginning of the next audio data. The length of big values is given in the side information. The size in bits of the big values section and the size in bits of the small values are also given in the side information thereby allowing one to infer the number of frequency lines of the small values. Since the total number is 576, this allows one to infer the number of samples in the zero values. The zero values are not encoded in the file. The frequency transform of the high fidelity audio data as encoded data in the MP3 format is defined as CiHF where CiHF is the coefficient of the ith frequency and i is in the range 0 to 575.

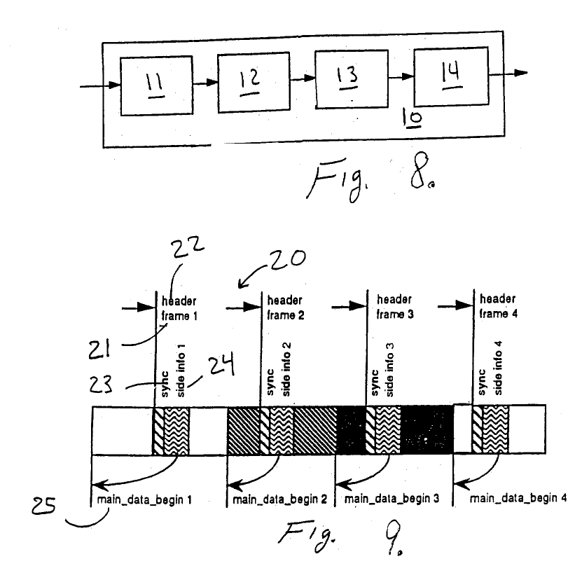

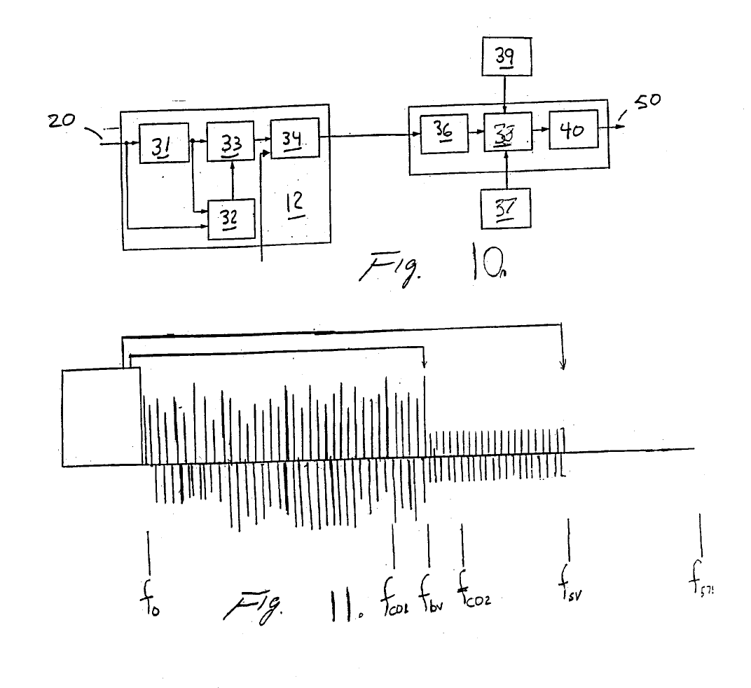

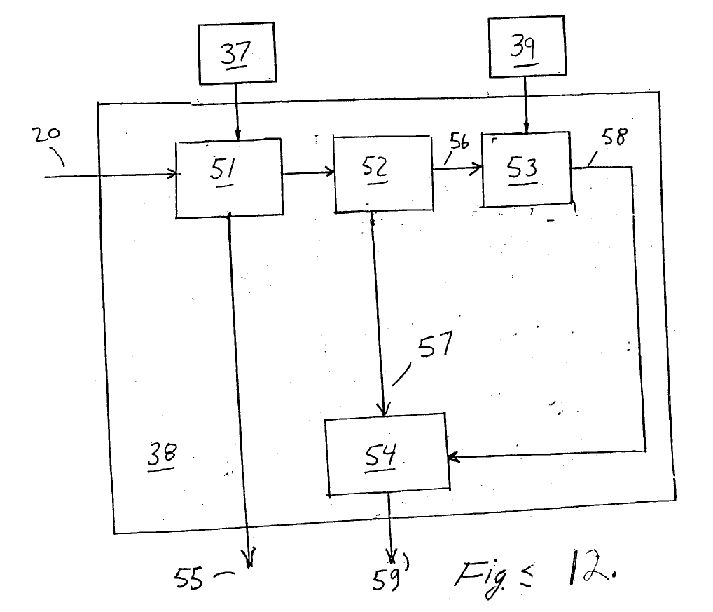

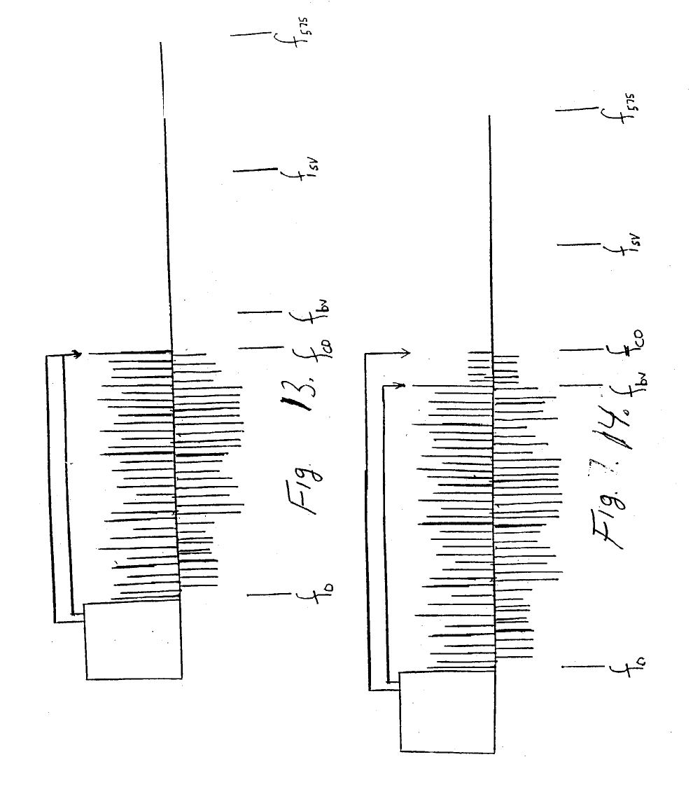

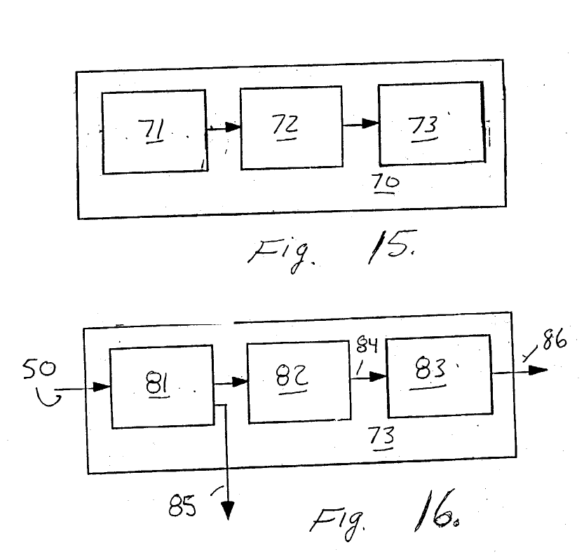

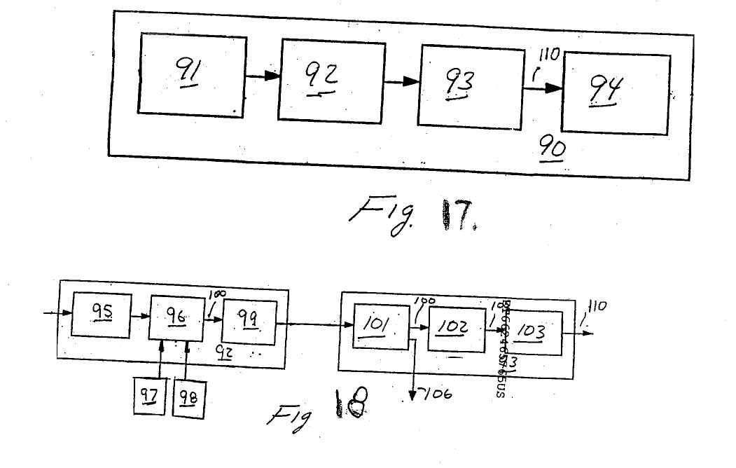

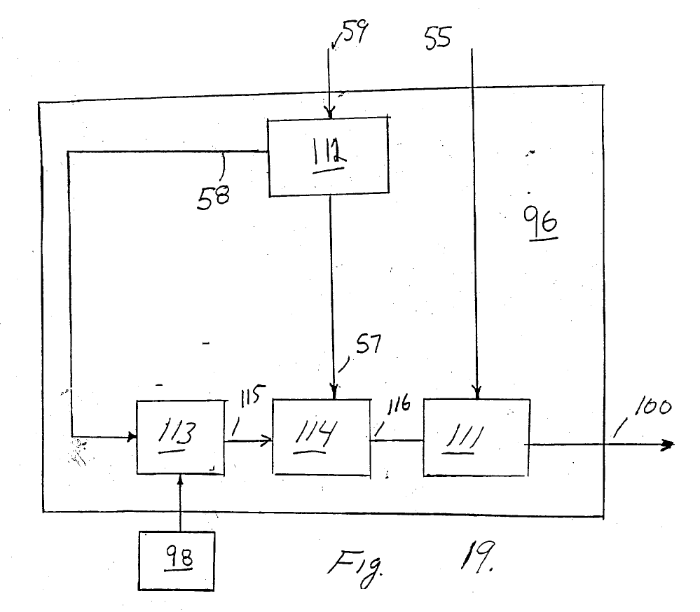

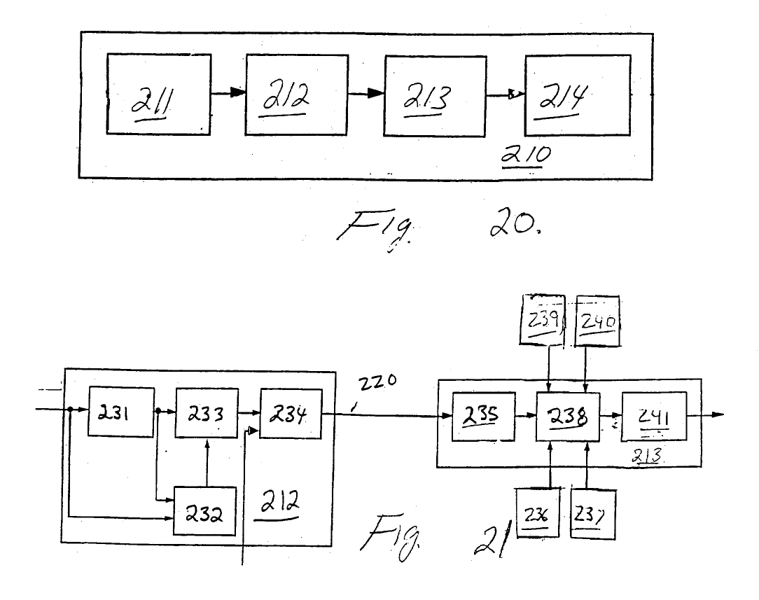

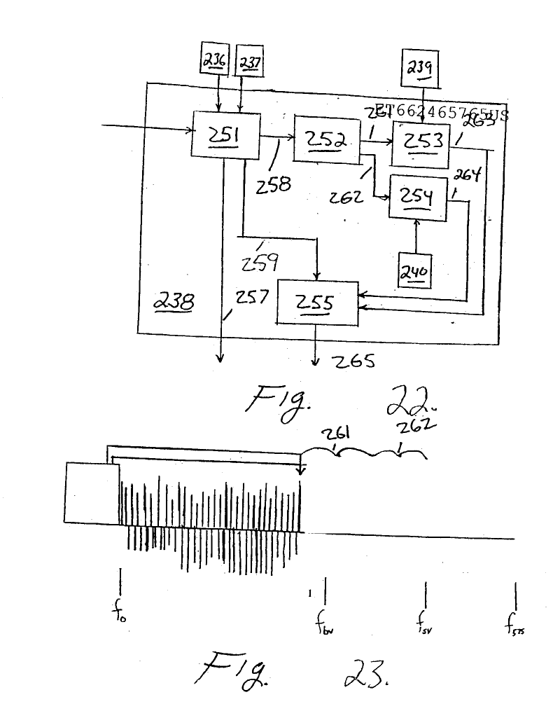

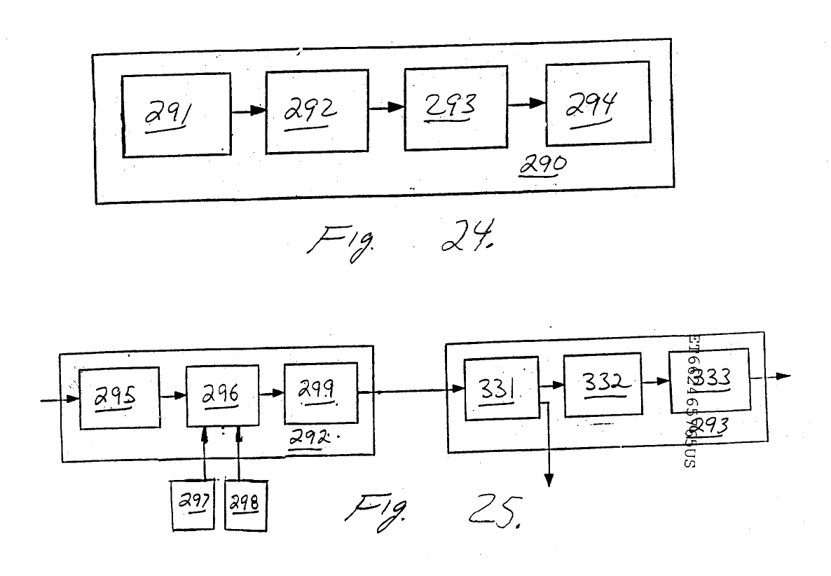

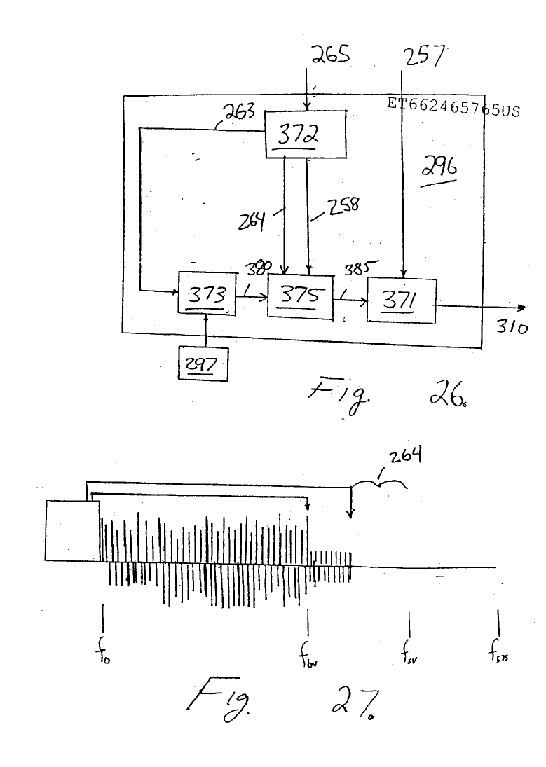

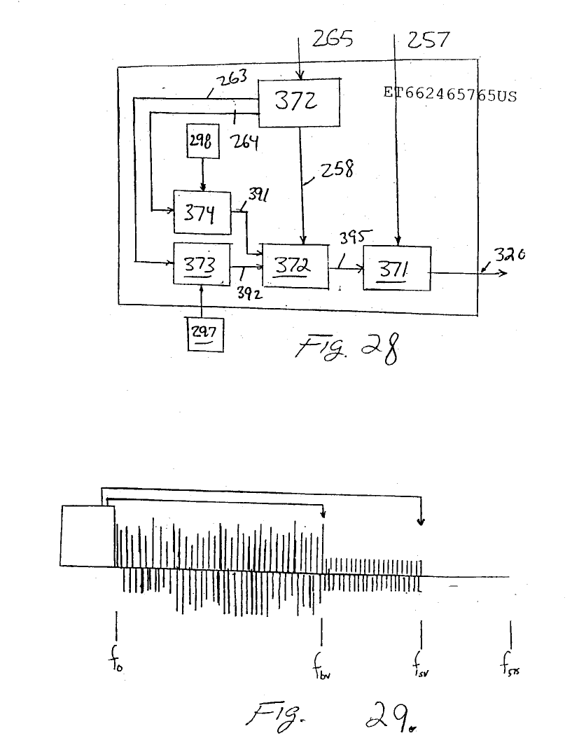

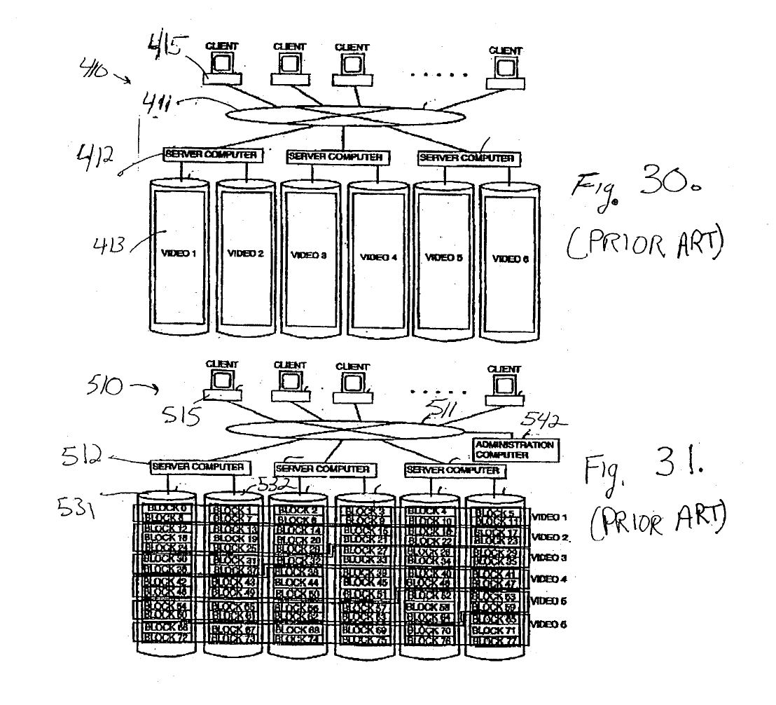

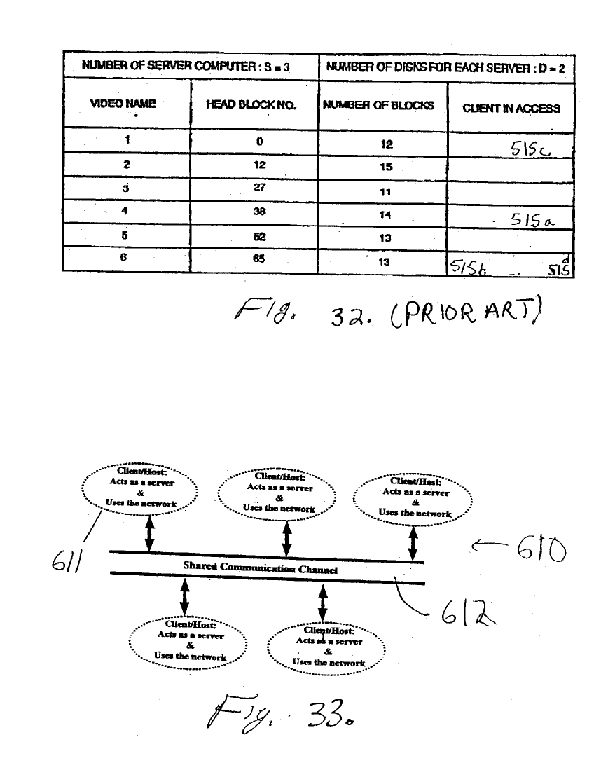

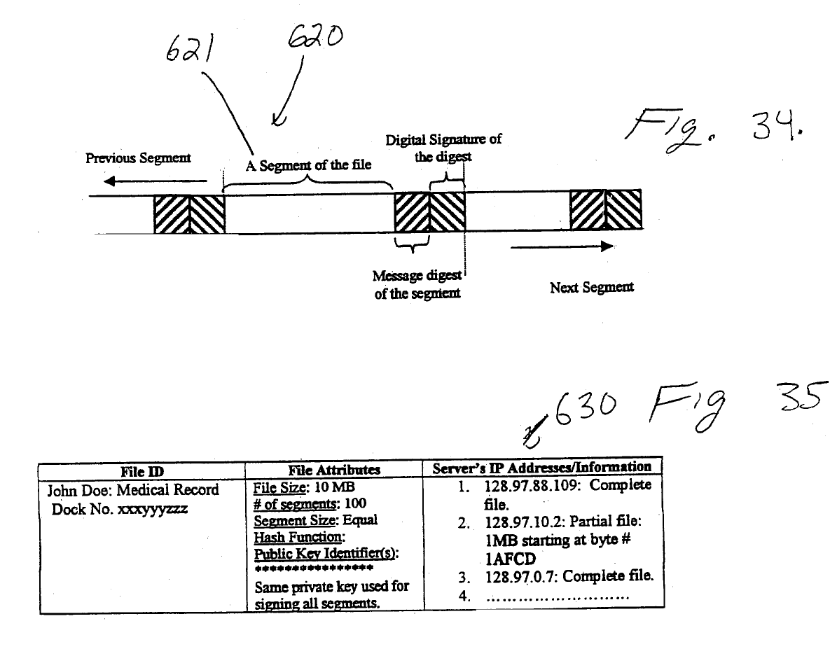

Referring to FIG. 10 the encoder 112 includes a mapping module 131, a psycho-acoustic model module 132, a quantizer and coding module 133 and a frame-packing module 134. The mapping module 131 receives the high fidelity audio data and is electrically coupled to both the psycho-acoustic model module 132 and the quantizer and coding module 133. The psycho-acoustic model module 132 also receives the high fidelity audio data and is electrically coupled to the quantizer and coding module 133. The frame-packing module 134 receives ancillary data and is electrically coupled to the quantizer and coding module 133. The output of the frame-packing module 34 is high fidelity audio data as encoded data in the MP3 format. Input audio samples are fed into the encoder 112. The mapping module 131 creates a filtered mid sub-sampled representation of the input of audio data. The mapped samples may be called either sub-band samples as in Layer I or II or transformed sub-band samples as in Layer III. The psycho-acoustic model module 132 creates a set of data to control the quantizer and coding module 133. These data are different depending on the actual encoder implementation. One possibility is to use an estimation of the masking threshold to do this quantizer control. The quantizer and coding module 133 creates a set of coding symbols from the mapped input samples. The frame-packing module 134 assembles the actual bit-stream from the output data of the other modules and adds other information, such as error correction if necessary. There are four different modes. These modes are a single channel mode, a dual channel mode, a stereo mode and a faint stereo mode. The dual channel mode is two independent audio signals coded within one bit-stream. The stereo mode is left and right signals of a stereo pair coded within one bit-stream. The faint stereo mode which is left and right signals of a stereo pair coded within one bit-stream with the stereo irrelevancy and redundancy exploited. The encoder 12 processes the digital audio signal in order to produce the compressed bit-stream for storage. The encoder algorithm is not standardized and may use various means far encoding such as estimation of the frequency auditory masking threshold, quantization, and scaling. However, the encoder output must be such that a decoder conforming to the specifications of clause 2.4 of the MP3 standard will produce an audio signal suitable for the intended application.

Still referring to FIG. 10 the first perceptual encrypter 113 includes a frame-unpacking module 135, a fidelity parameters module 136, a first perceptual encryption module 137 and a frame-packing module 138. The frame-unpacking module 135 receives the high fidelity audio data as encoded data in the MP3 format and is electrically coupled to the first perceptual encryption module 137. The first perceptual encryption module 137 is also electrically coupled to the fidelity parameter module 136. The first perceptual encryption module 137 receives fidelity parameters 139 from the fidelity parameter module 136. The frame-packing module 138 is electrically coupled to the first perceptual encryption module 137. The output of the frame-packing module 138 is a file 140 of restricted fidelity audio data as perceptually encrypted encoded data in the MP3 format. The first perceptual encrypter 113 includes a key module 140 in which a key 141 is stored.

Referring to FIG. 10 in conjunction with FIG. 9 and FIG. 11 the frame-unpacking module 135 unpacks the frames of the file 120 of high fidelity audio data as encoded data in the MP3 format and generates frequency coefficients of the unpacked frame of the file 120 of high fidelity audio data as encoded data in the MP3 format. The inputs of the first perceptual encryption module 137 are the frequency coefficients of the unpacked frame of the file 120 of high fidelity audio data as encoded data in the MP3 format, the fidelity parameters 139 from the fidelity parameters module 136 and the key 141 from the key module 140. In the general case the frequency transform of a file of restricted fidelity audio data as perceptually encrypted encoded data in the MP3 format is defined as CiRF where CiRF is defined by the equation: CiRF=SiCiHF where Si is the scaling factor for the coefficient CiHF of the ith frequency and i is in the range 0 to 575.

Referring to FIG. 12 in conjunction with FIG. 11 the first perceptual encryption module 137 includes a perceptual processor 151, a DES device 152 and a combiner 153. The DES device 152 is a block cipher. A block cipher takes a k-bit block and encrypts it with some n-bit key. In the case of the DES device 152 the block size is 64 bits and the key size is 56 bits. U.S. Pat. No. 4,731,843 teaches a DES device in a cipher feedback mode of k bits. The DES device 152 may be replaced by other suitable encryption devices, such as Blowfish. The first perceptual processor 151 receives the fidelity parameters 139 from the fidelity parameters module 136, the key 141 from the key module 140 and the frequency coefficients of the unpacked frames of the file 120 of high fidelity audio data as encoded data in the MP3 format from the unpacking module 131 of the encoder 112. The perceptual processor 151 generates unpacked frames of a file 154 of restricted fidelity audio data as encoded data in the MP3 format, data 155 to be encrypted and data 156 not to be encrypted. In the general case the data to be encrypted 155 will include all information, including the fidelity parameters 139, which is necessary to reconstruct CiHF from CiRF. For example, if Si=0, then CiHF is encrypted. Moreover the original information in the side information of the file 120 of high fidelity audio data encoded in the MP3 format might also need to be encrypted. The specific case of a low pass-filter perceptual encryption process (described below in FIG. 13 and FIG. 14) makes the description of the data 155 to be encrypted concrete. The DES device 152 encrypts the data 155 to be encrypted and generates encrypted data 157 by using the key 141. The combiner 153 combines the data not to be encrypted 156, the encrypted data 157 and the fidelity parameters 139 to form ancillary data 158. The frame-packing module 138 receives the frames of the file 154 of restricted fidelity audio data as encoded data in the MP3 format and the ancillary data 158 and combines them to form a file 159 of restricted fidelity audio data as perceptually encrypted encoded data in the MP3 format.

Referring to FIG. 12 in conjunction with FIG. 13 the fidelity parameter 139 in the specific case of a low-pass filter the fidelity parameter 139 is defined as a cut-off frequency, fco, which is in the range of f0 to f575. The scaling factor, Si, for the frequency coefficient CiHF of the high fidelity audio data as encoded data in The MP3 format is defined as Si=1 when i □ fco and Si=0 when i>fco. The fidelity parameter 139 is in a range from a cut-off frequency of cf0 to a cut-off frequency of cf575. Any data for the frequency coefficient CiHF which is for a frequency fi which is greater than the cut-off frequency becomes the data 155 to be encypted. Any data for a frequency coefficient CiHF which is for a frequency fi which is equal to or less than the cut-off frequency may include both big values and small values. Since the zero values are not coded, the decoder assumes that after the cut-off frequency, fco, all the frequency lines should be zero. This is known as a low-pass filter.

Referring to FIG. 13 in conjunction with FIG. 12 the output of the first perceptual encryption module 137 is the components of an unpacked frame of the file 159 of restricted fidelity audio as perceptually encrypted encoded data in the MP3 format. When the cut-off frequency is less than the highest big-value-frequency the first perceptual encryption module 137 takes each unpacked frame of the file 120 of high fidelity audio data as encoded data in the MP3 format and resets the big-values length to be the cut-off frequency, fco. The parameter in the standard “part 2.3 length” is reset as though all the Huffman code bits after the cut-off frequency, fco were removed. The Huffman code bits after the cut-off frequency, fco, form the data 155 to be encrypted. In addition, the correct values for big-values and “part 2.3 length” are also encrypted as part of the encrypted data 157 and stored in the ancillary data 158.

Referring to FIG. 14 in conjunction with FIG. 12 the output of the first perceptual encryption module 137 is the components of an unpacked frame of the file 159 of restricted fidelity audio as perceptually encrypted encoded data in the MP3 format. When the cut-off frequency, fco, is greater than the highest big-value-frequency then the total length of big values frequencies and small value frequencies is set to the cut-off frequency, fco. The parameter in the standard “part 2.3 length” is reset as though all the Huffman code bits after the cut-off frequency, fco were removed. The Huffman code bits after the cut-off frequency, fco, form the data 155 to be encrypted. The correct values for small-values and “part 2.3 length” are also encrypted as part of the encrypted data 57 and stored in the ancillary data 158. A method of correctly storing the ancillary data 158 is described next. In general one cannot assume that there is much (or any) ancillary data in a stream. In this case, the file will need to be increased in bit-rate (from 128 kbps to 160 kbps for instance) to accommodate the extra size. This could be done on only a few of the frames since the increase is around 800 bits per frame per jump. Only around 80 bits per frame extra are needed. So, every 10 frames the bit-rate can be increased for one frame thereby producing a VBR file or an encoder could make sure to leave a certain amount of spare bits each frame. The preceding technique embeds an additional data stream into the ancillary data of an MP3 bit-stream. All decoders will ignore this data, but this data may be encrypted for security reasons.

Referring to FIG. 15 a first receiving system 170 includes a receiver/storage device 171, a decoder 172 and a player 173. The receiver/storage device 171 is electrically coupled to the decoder 172. The decoder 172 is electrically coupled to the player 173.

Referring to FIG. 16 in conjunction with FIG. 15 the decoder 173 includes a frame-unpacking module 181, a reconstruction module 182 and an inverse-mapping module 183. The frame-unpacking module 81 receives the file 159 of restricted fidelity audio data as perceptually encrypted encoded data in the MP3 format and is electrically coupled to the reconstruction module 182. The inverse-mapping module 183 is electrically coupled to the reconstruction module 182. The output of the inverse-mapping module 183 is a file 184 of restricted fidelity audio data. The unpacking module 181 does error detection. The data is unpacked to recover the various pieces of information. The reconstruction module 182 reconstructs the quantized version of the set of mapped samples. The inverse-mapping module 183 transforms these mapped samples back into uniform PCM.

Referring to FIG. 17 a second receiving system 190 includes a receiver/storage device 191, a first perceptual decrypter 192, a decoder 193 and a player 194. The receiver/storage device 191 is electrically coupled to the first perceptual decrypter 192. The decoder 193 is electrically coupled to the player 194.

Referring to FIG. 18 the first perceptual decrypter 192 includes a frame-unpacking module 195, a first perceptual decryption module 196 and a frame-packing module 197. The first perceptual decrypter 192 requires a key 198 and is electrically coupled to the decoder 193. The key 198 of the first perceptual decrypter 92 is identical to the key 141 of the first perceptual encrypter 113. The frame unpacking module 195 receives the file 159 of restricted fidelity audio data as perceptually encrypted encoded data in the MP3 format and unpacks the file 159 into frames of the file 154 of restricted fidelity audio data as encoded data in the MP3 format and the ancillary data 158. The first perceptual decryption module 196 processes the frames of the file 154 of restricted fidelity audio data as encoded data in the MP3 format using the key 198 and the ancillary data 158 to generate the unpacked frames of the file 120 of high fidelity audio data as encoded data in the MP3 format and ancillary data 199.

Referring to FIG. 18 in conjunction with FIG. 17 the decoder 193 includes a frame-unpacking module 201, a reconstruction module 202 and an inverse-mapping module 203. The frame-unpacking module 201 receives the file 120 of high fidelity audio data as encoded data in the MP3 format and unpacks the packed frames of the file 120 of high fidelity audio data as encoded data in the MP3 format and ancillary data. The frame-unpacking module 201 is electrically coupled to the reconstruction module 202 and sends the unpacked frames of the file 120 of high fidelity audio data as encoded data in the MP3 format to the reconstruction module 202 to generate a reconstructed file 104 of high fidelity audio data and stores the ancillary data. The inverse mapping module 203 is electrically coupled to the reconstruction module 202 and receives the reconstructed file 204 of high fidelity audio data. The inverse mapping module 203 is electrically coupled to the player 194. The inverse mapping module 203 generates a high fidelity audio signal 205 and sends the high fidelity audio signal 105 to the player 194.

Referring to FIG. 19 the first perceptual decryption module 196 includes an inverse perceptual processor 211, an inverse DES device 212 and a splitter 213. The inverse perceptual processor 211 receives the frames of the file 154 of restricted fidelity audio data as encoded data in the MP3 format of the unpacked file 159 of restricted fidelity audio data as perceptually encrypted encoded data in the MP3 format from the frame-unpacking module 195. The splitter 213 receives the ancillary data 158 of the unpacked file 159 of restricted fidelity audio data as perceptually encrypted encoded data in the MP3 format from the frame-unpacking module 195. The splitter 213 is electrically coupled to the inverse perceptual processor 211 and splits off from the ancillary data 158 the fidelity parameters 139 and the data 156 not to be encrypted. The splitter 213 sends the fidelity parameters 139 and the data 156 not to be encrypted to the inverse perceptual processor 211. The splitter 213 is also electrically coupled to the inverse DES device 212 and splits off from the ancillary data 158 the encrypted data 157. The splitter 213 sends the encrypted data 157 to the inverse DES device 212. The inverse DES device 212 uses the key 198 to decrypt the encrypted data 157 and regenerates the data 155 to be encrypted. The inverse DES device 212 is electrically coupled to the inverse perceptual processor 211 and sends the decrypted data 214 to the inverse perceptual processor 211. The inverse perceptual processor 211 processes the file 154 of restricted fidelity audio data as encoded data in the MP3 format, the decrypted data 214, the data 156 not to be encrypted and the fidelity parameters 139 and regenerates the file 120 of high fidelity audio data as encoded data in the MP3 format.

Referring to FIG. 20 a third distribution system 310 includes an audio source 311, an encoder 312, a second perceptual encrytper 313 and a server 314. The audio source 311 may be a compact disk and a player and provides a high fidelity audio signal. The encoder 312 encodes the high fidelity audio signal and generates a file 320 of high fidelity audio data as encoded data in the MP3 format. As discussed earlier the encoder 312 may also encode the high fidelity audio signal and generate a file of high fidelity format audio data as encoded data in a format other than the MP3. format

Referring to FIG. 21 in conjunction with FIG. 20 the second perceptual encrypter 313 perceptually encrypts the file 320 of high fidelity audio data as encoded data in the MP3 format and generates a file 330 of restricted fidelity audio data as twice-perceptually encrypted encoded data in the MP3 format. The server 314 either stores in a memory bank or distributes from the memory bank the file 330 of restricted fidelity audio data as twice-perceptually encrypted encoded data in the MP3 format.

Referring to FIG. 21 the encoder 312 includes a mapping module 331, a psycho-acoustic model module 332, a quantizer and coding module 333 and a frame-packing module 334. The mapping module 331 receives the high fidelity audio data. The mapping module 331 is electrically coupled to both the psycho-acoustic model module 332 and the quantizer and coding module 333. The psycho-acoustic model module 332 also receives the high fidelity audio data and is electrically coupled to the quantizer and coding module 333. The frame-packing module 334 receives ancillary data. The frame-packing module 334 is electrically coupled to the quantizer and coding module 333. The output of the frame-packing module 334 is the file 320 of high fidelity audio data as encoded data in the MP3 format.

Still referring to FIG. 21 the second perceptual encrypter 313 includes a frame-unpacking module 335, a fidelity parameter module 336, a second perceptual encryption module 337, a key module 338 and a frame-packing module 339. The frame-unpacking module 335 and is electrically coupled to the second perceptual encryption module 337 and receives the file 30 of high fidelity audio data as encoded data in the MP3 format. The frame-unpacking module 335 unpacks the frames of the file 320 of high fidelity audio data as encoded data in the MP3 format and generates the frequency coefficients of the unpacked frames of the file 320 of high fidelity audio data as encoded data in the MP3 format. The second perceptual encryption module 337 is also electrically coupled to the fidelity parameter module 336. The frame-packing module 339 is electrically coupled to the second perceptual encryption module 337. The output of the frame-packing module 339 is the file 330 of restricted fidelity audio data as twice-perceptually encrypted encoded data in the MP3 format. The fidelity parameter module 336 provides first fidelity parameters 341 and second fidelity parameters 342. The key module 338 provides a first key 343 and a second key 344. The inputs of the second perceptual encryption module 337 are the frequency coefficients of the unpacked frames of the file 320 of high fidelity audio data as encoded data in the MP3 format, the first and second fidelity parameters 341 and 342 and the first and second keys 343 and 344.

Referring to FIG. 22 the second perceptual encryption module 337 includes a perceptual processor 351, a first DES device 352, a second DES device 353, a splitter 354 and a combiner 355. The perceptual processor 351 receives the first fidelity parameters 341 and second fidelity parameters 342 from the fidelity parameters module 336 and the frequency coefficients of unpacked frames of the file 320 of high fidelity audio data as encoded data in the MP3 format from the frame-unpacking module 331 of the encoder 312.

Referring to FIG. 22 in conjunction with FIG. 23 the perceptual processor 351 generates unpacked frames of a file 356 of restricted fidelity audio data as encoded data in the MP3 format, data 357 to be encrypted and data 358 not be encrypted. The splitter 354 splits the data 357 to be encrypted into a first portion 359 of the data 357 to be encrypted and a second portion 360 of the data 357 to be encrypted. The first DES device 352 encrypts the first portion 359 of the data 357 to be encrytped and generates a first portion 361 of encrytped data by using the first key 343. The second DES device 353 encrypts the second portion 360 of the data 357 to be encrytped and generates a second portion 362 of encrytped data by using a second key 344. The combiner 355 combines the first portion 361 of encrytped data, the second portion 362 of encrytped data, the first fidelity parameters 341, the second fidelity parameters 342 and the data 358 not to be encrypted to form the ancillary data 365. The file 356 of restricted fidelity audio data as encoded data in the MP3 format and the ancillary data 365 are combined in the frame-packing module 338 to form a file 370 of restricted fidelity audio data as twice-perceptually encrypted encoded data in the MP3 format.

Referring to FIG. 24 a third receiving system 390 includes a receiver/storage device 391, a second perceptual decrypter 392, a decoder 393 and a player 394. The receiver/storage device 391 is electrically coupled to the second perceptual decrypter 392. The second perceptual decrypted 392 is electrically coupled to the decoder 393. The decoder 393 is electrically coupled to the player 394. The receiver/storage device receives the file 370 of restricted fidelity audio data as twice-perceptually encrypted encoded data in the MP3 format. The frame-unpacking module 395 receives the file 370 of restricted fidelity audio data as twice-perceptually encrypted encoded data in the MP3 format from the receiver/storage device 391. The frame-unpacking module 395 unpacks the file 370 of restricted fidelity audio data as twice-perceptually encrypted encoded data in the MP3 format and regenerates the file 356 of restricted fidelity audio data as encoded data in the MP3 format and the ancillary data 365. The ancillary data 365 contains the first portion 361 of the encrytped data, the second portion 362 of encrytped data, the first fidelity parameters 341, the second fidelity parameters 342 and the data 358 not to be encrypted.

Referring to FIG. 25 the second perceptual decrypter 392 includes a frame-unpacking module 395, a second perceptual decryption module 396, a first key-receiving module 397, a second key-receiving module 398 and a frame-packing module 399. The frame-unpacking module 395 is electrically coupled to the second perceptual decryption module 396. The second perceptual decryption module 396 is electrically coupled to the first and second key-receiving modules 397 and 398. The second perceptual decryption module 396 is also electrically coupled to the frame-packing module 399. The second perceptual decrypter 292 requires a first key 401 and a second key 402. The first key 401 is identical to the first key 343 of the second perceptual encrypter 313. The second key 402 is identical the second key 344 of the second perceptual encrypter 313. After having received the regenerated unpacked frames of the file 356 of restricted fidelity audio data as encoded data in the MP3 format and the ancillary data 365 the second perceptual decryption module 396 processes the file 356 of restricted fidelity audio data as encoded data in the MP3 format and the ancillary data 365 and generates unpacked frames of either a file 410 of intermediate fidelity audio data as once-perceptually decrypted, twice-perceptually encrypted encoded data in the MP3 format or a file 320 of high fidelity audio data as twice-perceptually decrypted, twice-perceptually encrypted encoded data in the MP3 format. The frame-packing module 399 packs the unpacked frames of either the file 410 of intermediate fidelity audio data as once-perceptually decrypted, twice-perceptually encrypted encoded data in the MP3 format or the file 320 of high fidelity audio data as twice-perceptually decrypted, twice-perceptually encrypted encoded data in the MP3 format.

Still referring to FIG. 25 the decoder 393 includes a frame-unpacking module 431, a reconstruction module 432 and an inverse-mapping module 433. The frame-unpacking module 431 receives the packed frames of either the file 410 of intermediate fidelity audio data as once-perceptually decrypted, twice-perceptually encrypted encoded data in the MP3 format or the file 320 of high fidelity audio data as twice-perceptually decrypted, twice-perceptually encrypted encoded data in the MP3 format. The frame-unpacking module 431 is electrically coupled to the reconstruction module 432 and sends the unpacked frames of either the file 410 of intermediate fidelity audio data as once-perceptually decrypted, twice-perceptually encrypted encoded data in the MP3 format or the file 420 of high fidelity audio data as twice-perceptually decrypted, twice-perceptually encrypted encoded data in the MP3 format to the reconstruction module 432. The reconstruction module 432 generates either a reconstructed file 440 of intermediate fidelity audio data or a reconstructed file 450 of high fidelity audio data. The inverse mapping module 433 is electrically coupled to the reconstruction module 432 and receives either reconstructed file 440 of intermediate fidelity audio data or the reconstructed file 450 of high fidelity audio data. The inverse mapping module 433 generates either an intermediate fidelity audio signal 450 or a high fidelity audio 460.

Referring to FIG. 26 the second perceptual decryption module 397 includes an inverse perceptual processor 471, a splitter 472, a first inverse DES device 473, a second inverse DES device 474 and a combiner 475. The inverse perceptual processor 471 is electrically coupled to the frame-unpacking module 395 and receives the file 356 of restricted fidelity audio data as encoded data in the MP3 format from the frame-unpacking module 395. The splitter 472 is electrically coupled to the frame-unpacking module 395 and receives the ancillary data 365 from the frame-unpacking module 395. The splitter 472 is electrically coupled to the first inverse DES device 473. The splitter 472 splits off from the ancillary data 365 the first portion 362 of encrypted data and sends the first portion 362 of encrypted data to the first inverse DES device 473. The splitter 472 is electrically coupled to the combiner 475 and splits off from the ancillary data 365 the second portion 364 of encrypted data, the data 358 not to be encrypted, the first fidelity parameters 341 and the second fidelity parameters 342. The splitter 472 sends the second portion 364 of encrypted data, the data 358 not to be encrypted, the first fidelity parameters 341 and the second fidelity parameters 342 to the combiner 475.

Still referring to FIG. 26 in conjunction with FIG. 27 the first inverse DES device 473 uses the first key 401 to decrypt the first portion 361 of encrypted data and regenerates decrypted data 480 which is identical to the first portion 359 of the data 357 to be encrypted. The combiner 474 is electrically coupled to the first inverse DES device 473 and receives the decrypted data 480 from the first inverse DES device 473. The combiner 475 combines the decrypted data 480 with the data 358 not to be encrypted, the second portion 362 of encrytped data, the first fidelity parameters 341 and the second fidelity parameters 357 and generate combines them to form a decryption file 485. The inverse perceptual processor 411 combines the file 355 of restricted fidelity audio data as encoded data in the MP3 format and the decryption file 485 and generates unpacked frames of the file 410 of intermediate fidelity audio data as once-perceptually decrypted, twice-perceptually encrypted encoded data in the MP3 format. The frame-packing module 399 packs the unpacked frames of a file 410 of intermediate fidelity audio data as once-perceptually decrypted, twice-perceptually encrypted encoded data in the MP3 format.

Referring to FIG. 28 the second perceptual decryption module 397 includes an inverse perceptual processor 471, a splitter 472, a first inverse DES device 473, a second inverse DES device 474 and a combiner 475. The inverse perceptual processor 471 is electrically coupled to the frame-unpacking module 395 and receives the file 356 of restricted fidelity audio data as encoded data in the MP3 format from the frame-unpacking module 395. The splitter 472 is electrically coupled to the frame-unpacking module 395 and receives the ancillary data 365 from the frame-unpacking module 395. The splitter 472 is electrically coupled to the first inverse DES device 473. The splitter 472 splits off from the ancillary data 365 the first portion 363 of encrypted data and the second portion 364 of encrypted data sends the first portion 361 of encrypted data to the first inverse DES device 473 and the second portion 362 of encrypted data to the second inverse DES device 474. The splitter 472 is electrically coupled to the combiner 475 and splits off from the ancillary data 365 the data 358 not to be encrypted, the first fidelity parameters 341 and the second fidelity parameters 342. The splitter 472 sends the data 358 not to be encrypted, the first fidelity parameters 341 and the second fidelity parameters 342 to the combiner 475.

Still referring to FIG. 26 in conjunction with FIG. 27 the first inverse DES device 473 uses the first key 401 to decrypt the first portion 363 of encrypted data and generates first decrypted data 491 identical to the first portion 359 of the data 357 to be encrypted. The second inverse DES device 474 uses the second key 402 to decrypt the second portion 364 of encrypted data and generates second decrypted data 492 identical to the second portion 360 of the data 357 to be encrypted. The combiner 474 is electrically coupled to the first inverse DES device 473 and the second inverse DES device 474 and receives the first and second decrypted data 491 and 492 from the first and second inverse DES devices 473 and 474, respectively. The combiner 475 combines the first and second decrypted data 491 and 492 with the data 358 not to be encrypted, the second portion 362 of encrytped data, the first fidelity parameters 341 and the second fidelity parameters 357 and generate combines them to form a decryption file 495. The inverse perceptual processor 411 combines the file 355 of restricted fidelity audio data as encoded data in the MP3 format and the decryption file 495 and generates unpacked frames of the file 420 of high fidelity audio data as twice-perceptually decrypted, twice-perceptually encrypted encoded data in the MP3 format. The frame-packing module 399 packs the unpacked frames of a file 420 of high fidelity audio data as twice-perceptually decrypted, twice-perceptually encrypted encoded data in the MP3 format.

Restricting the fidelity of an MP3 file enables electronic commerce solutions in which restrict fidelity or low quality audio files, such as either AM radio quality or FM radio quality, are given away for free, and the high fidelity audio files, such as compact disk quality, are sold. This model allows music retailer to take advantage of peer-to-peer networking rather than being threatened by it. The high frequency data is hidden and encrypted. These ancillary bits are used to hide information from a decoder. The content provider supplies a frequency line from 1 to 576 to act as the cut-off length.

In addition to the low pass filter described here, other types of transformations could be applied that similarly restrict quality but preserve the format of the file. A separate idea would be to restrict the stereo component, but allow the mono audio to go on. This could be obtained by using the joint stereo mode of the MPEG 1 standard. In joint stereo, rather than coding left and right channels independently, M=L˜is coded, and also S=is coded. By using the same technique of moving certain data into the ancillary data and then encrypting it, one can produce a mono file from a stereo file. The details of this method are not described but should be clear once the low pass filter method is understood.

Perceptual encryption restricts access to targeted segments of audio quality. By using these techniques one could restrict compact disk quality input files to sound like AM, FM, FM-stereo or cassette quality. A simple model would allow for a content provider to select a quality that he is willing to give away for free, and then set a price for the key to unlock compact disk quality audio. This is not unlike the consumer experience with radio. To the consumer, the radio is free, but lower quality. Consumers get high quality only when they purchase the compact disk. Additionally, by allowing some content to go at zero cost, namely the low fidelity versions, users are able to use peer-to-peer networking services, such as Napster and Gnutella, in a way that does not infringe on copyrights. A secure sharing protocol allows peer-to-peer networking only with the consent of the authors of the content. Perceptual encryption coupled with a system for vending keys over the internet allows for an innovative solution to the digital music problem.

Keys may be sent on-line. The smallest secure key possible is preferable. U.S. Pat. No. 5,960,411 teaches a system for placing an order to purchase an item such as a key via the Internet. The order is placed by a purchaser at a client system and received by a server system. Upon purchase a key is sold to the user. The distribution of audio files may be decentralized by broadcasting to everyone, distributed on compact disk or transferred by a hand-held devices. Each user has a low bandwidth two connection to the Internet. Upon sampling content which is obtained by any method the user may purchase the key on-line. Since the key and user identification are the only things sent over the network, only a few bits need to be sent (at most 1000) which can be done with any modem (even 1200 baud) in much less than a second. This is well suited to cell phones, palm pilots, other hand-held devices or general purpose computers.

Referring to FIG. 30 a video server system of the prior art includes a network 501 and server computers 502. The server computers 502 are connected to the network 501 and have a function as a video server, magnetic disk unit 503 which are connected to the server computers 502 and stores video programs, clients 505 which are connected to the network 501 and demand the server computers 502 to read out a video program. Each server computer 502 has a different plurality of set of video programs such as a movie stored in the magnetic disk units 503. A client 505 therefore reads out a video program via one of the server computers 502 which has a magnetic disk units 503 where a necessary video program is stored.

Referring to FIG. 31 in conjunction with FIG. 32 a video server system 510 of U.S. Pat. No. 5,630,007 includes a network 511, such as Ethernet and ATM, and a plurality of server computers 512. Application programs are connected to the network 511. Magnetic disk units 531 and 532 are connected to the server computers which sequentially store distributed data, such as a video program, which has been divided (referred to as “striping”) to be stored in the magnetic disk units 531 and 532, client computers 505 which are connected to the network 501 and receive video program, application programs which operate in the client computers 505, driver programs as an access demand means which demand access to the video program 504 having been divided and sequentially stored in magnetic disk units 531 and 532 in response to a demand to access from application programs. Client-side network interfaces carry out such process as TCP/IP protocol in the client computers 505 and realize interfaces between clients and the network 501, server-side network interfaces which carry out such processes as TCP/IP protocol in the server computers 502 and realizes interface between servers and the network 501, server programs which read data block out of magnetic disk units 531 and 532 to supply it to the server-side network interfaces the original video program 511 which has not yet been divided nor stored, administration computer 512 connected to the network 501, administration program 513 operated in the administration computer 512 which administrates the video program having been divided and stored in magnetic disk units 531 and 532 and the server computers 502. The administration computer-side network interface carries out such process as TCP/IP protocol in the administration computer 512 and realizes an interface between the administration computer 512 and the network 501, and a large capacity storage 515 such as CD-ROM, which is connected to the computer 512 and the original video program 11 is stored therein.

Still referring to FIG. 31 only two magnetic disk units are connected to each server computer. Each of the three server computers 502 is connected to two magnetic disk units, respectively, and also connected to the administration computer 512 and a plurality of client computers 505 which are devices on the video-receiving side, via the network 501. Each magnetic disk unit 531 or 532 is divided into block units per a certain amount. Six video programs, denoted by videos 1˜6 are stored in 78 blocks denoted by blocks 0˜77. Each video program is stored as if data was striped where data has been divided and distributed over the plurality of the magnetic disk units 531 and 532. Video 1 is sequentially stored in the blocks 0˜11, and video 2 is sequentially stored in the blocks 12˜26. Videos 3˜6 are also stored in the blocks, respectively.

Referring to FIG. 33 a distributed network 610 includes a plurality of hosts 611 and a shared communication channel 612. Each host is coupled to the shared communication channel 612. Each host 611 may act as both a client and a server and uses the distributed network 610, but not all of the hosts need to act as either a client or a server. The downloading process may be called incasting because it can be construed as a reverse of broadcasting. In broadcasting, a file 620 is transmitted to multiple locations generating multiple copies of the file 620. In contrast, in incasting fragments 621 of multiple copies of the file 620 are gathered together to generate a single copy of the file 620. There is a format for creating and storing multiple copies of the files 620 and a protocol to guarantee fast in the sense that it utilizes the maximum available bandwidth for the task and accurate transfer of the requested content/file 620 to a client in the sense that the content of the copied file 620 is the same as that of the stored one. Incasting would constitute the backbone of the distributed network 610. Incasting addresses a key technological issue of how to provide a high-quality service in terms of both accuracy and speed for transferring a file 620, which a client has requested, to the client on the distributed network 610 that support content replication. The same content or file 620 can reside in several different servers on the distributed network 610. This could be either because the file 620 was created at only one server and distributed to several others or because the same content was created or procured independently at different servers. Incasting will work even if no individual server has the complete file 620, but as long as the complete file 620 is collectively available on the whole distributed network 610. There is a unique identification tag for each content or file 620 residing on the network. A list of all accessible content/files 620 is either available from one central server or is maintained in a distributed manner. Several servers may contain a complete or partial lists of the contents. Such a list would contain the identification tags of all the contents. For each content/file 620 it would list all the servers that contain a copy of the file 620.

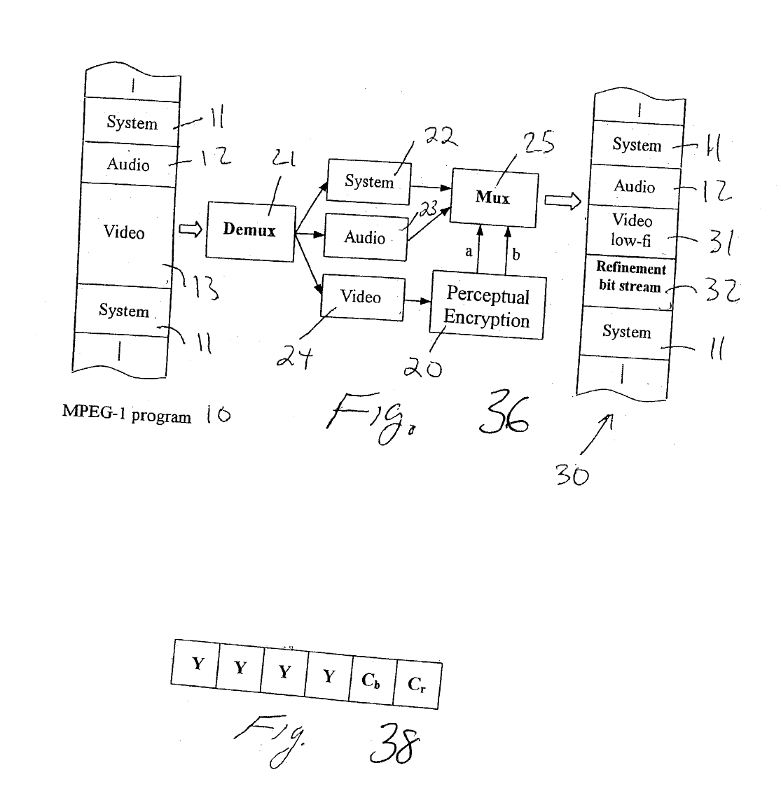

Referring to FIG. 34 the file 620 is divided into a number of segments 621. Each segment 621 has a secure hash function. The secure hash function is used to compute a message digest, which is then signed. The number of segments 621, their locations, the hash function(s) and the public key(s) for the digital signatures are recorded as attributes of the file 620. The incasting process will work for any existing format for storing files 620 which follows the convention of being byte aligned. Hence, any server can handle a request, where it is asked to transmit blocks of bytes along with start and end indices. For example, a typical request could be for the transmission of M bytes of a file 620 starting at the kth byte. However, for guaranteeing the integrity of the files 620 and for avoiding expensive retransmissions of potentially erroneous downloads, the following format for storing files 620 and partitioning the file 620 into a specified number of segments 621 is recommended. For each segment 621, compute a message digest of the contents using a secure hash function. The message digest basically acts as a unique identifier for the contents of the segment 621 and on reception, can be used to guarantee the integrity of the contents of the segment 621. In order to guarantee authenticity (e.g., the fact that the file 620 was indeed created by the owner), one can in addition sign the digest. Thus, if one has the segment 621, the message digest and the digital signature of the file 620, then one can verify authenticity (check that the signature matches the digest) and then check for integrity (i.e., the digest matches the contents of the segment 21). For example, the Secure Hash Standard (SHS) can be used to generate 660-bit message digests for the segments 621. The Digital Signature Standard (DSS) can then be used to generate a 320-bit digital signature of the digest. Other standard hash functions (e.g., MD4 and MD5) and digital signature schemes (e.g., those based on RSA) can be used as well. The number of segments 21 and their starting locations can be stored in the file description. Moreover, if the feature of digital signature is used, then the public key(s) of the owner of the file 20 and the hash function used should also be made available in the description of the files 620.

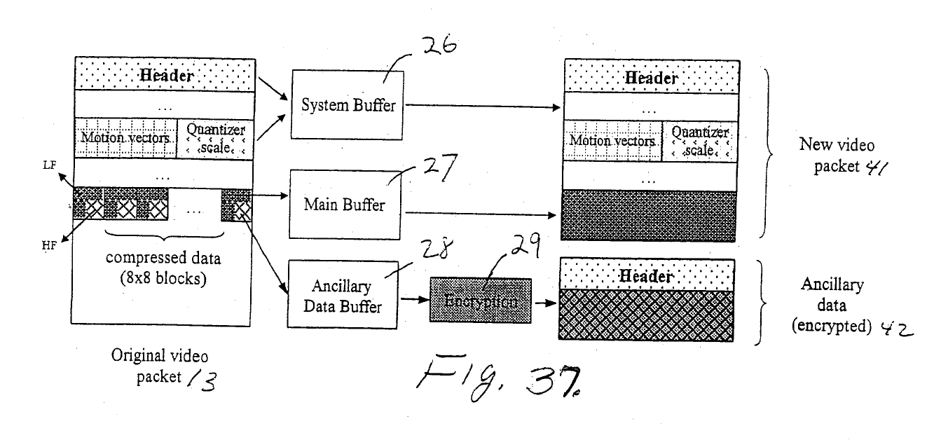

Referring to FIG. 35 each entry for a file 620 in a global list 630 contains all the necessary information about the file 620 so that a client can successfully complete an incasting process. The client wishing to download a file 620 goes through the following step of searching the distributed network 610. The client first searches the global list(s) 630 of content/files 620 (to be referred to as the network directory from hereon) to determine the availability of the desired file 620 on the distributed network 610. It is not necessary that a global network directory be maintained at one or several servers. The network directory could itself be maintained in a distributed fashion (e.g., the scheme adopted in the Gnutella network) in which case, a distributed search for the desired content/file 620 will be carried out. In both cases, the following information is returned to the client. A list of (IP) addresses for the servers where the file 620 is located partially or in full. If a server has only parts of the desired file 620, then a succinct description (e.g., start and end byte numbers of contiguous portions of the file 620) of the content stored in the server is also included. If the file 620 is divided into segments 21 along with corresponding digest and digital signature, then the client will also receive descriptions of the segments 21, and the types of hash functions and public key(s) used for the digital signature. The client now has all the storage information about the desired file 20, but does not know the exact availability of bandwidth at the eligible servers for any download request. Using an adaptive incasting algorithm the client is able to virtually segments the file 620 into a number of distinct parts and requests each part from a distinct server. The exact nature of the virtual segmentation procedure will depend on a number of factors, including, the bandwidth available to the client, any prior knowledge about the bandwidth available to different servers and also the storage format of the requested file 620. Since, these are all very implementation-dependent, specific details of the virtual segmentation procedure are not provided. Different servers will respond at different time intervals to the above-mentioned requests. For example, the servers that have high available bandwidth will respond faster than those servers with slower access, and some servers might not respond at all. The client can then have an online estimate of the traffic and can change the frequency and size of the requests adaptively. Some servers that do not respond during a pre-specified time interval could dropped from the list altogether or could be tried again after an interval of time, if the other active servers are not fast enough. This scheme allows complete flexibility and can be used to saturate the available bandwidth of the client. As the above-mentioned adaptive protocol is carried out, the desired file 20 is received in contiguous chunks of bytes. Since the segmentation format of the file 620 is known to the client, it can always check whether any complete segment 21 of the file 620 has been downloaded or not. Once a full segment 621 of the file 620 is downloaded, it can first verify authenticity of the message digest using the digital signature and the public key and then verify the accuracy/integrity of the segment 621 by comparing the downloaded message digest with a digest that it computes on the content of the segment 621 (using a pre-specified hash function). If any of these verification procedures fails, then it discards the whole segment 621 and starts the requests for the bytes in that segment 621 again. Clearly, there is a tradeoff here between the number of original segments 621 in the file 620 and the number of bytes that might be downloaded multiple times. If there are more segments 621 in the file 620, then first the chance that a segment 621 is corrupted is small, and second even if some bytes are corrupted then only a small number of bytes will need to be downloaded again. However, more segments 621 would mean a larger overhead in terms of the total size of the file 620. For example, if the Digital Signature Standard is used, then each segment 621 has to have at least an additional 60 bytes: 660 bits (20 bytes) for the message digest and 320 bits (40 bytes) for the digital signature. Incasting allows a client to efficiently download a file 620 from the distributed network 610 by putting together fragments of the file 620 obtained from different servers that maintain partial or complete copies of the desired file 620. While the well-known broadcasting procedure creates copies of the same file 620 at many different destination servers incasting recreates a copy of the file 620 by optimally piecing together fragments of the file 620 obtained from multiple target servers. Incasting provides both a suitable format for storing the files 620 and a protocol for gathering the distributed content to create an accurate copy. The same content/file 620 can reside in several different servers on the distributed network 610. This could be either because, the file 620 was created at only one server, and then distributed to several others, or because the same content was created or procured independently at different servers. Incasting will work even if no individual server has the complete file 620, but as long as the complete file 620 is collectively available on the whole distributed network 610. There is a unique identification tag for each content or file 620 residing on the network. A list of all accessible content/files 620 is either available from one central server, or is maintained in a distributed manner (i.e., several servers contain the complete or partial lists of the contents). Such a list would contain the identification tags of all the contents, and for each content/file 620 it would list all the servers that contain a copy of the file 620. The most frequent use of the distributed network 610 is for downloading purposes. A client looks up the content list, and wants to download a particular content/file 620 from the distributed network 610. The existing protocols for this process are extremely simple, and can be described in general as follows. The client or a central server searches the list of servers that contain the desired file 620 and picks one such server (either randomly or according to some priority list maintained by the central server) and establishes a direct connection between the client requesting the down load and the chosen server. This connection is maintained until the entire file 620 has been transferred. Exact implementation might vary from one protocol to another; however, the fact that only one server is picked for the transfer of the entire requested file 620 remains invariant.

The distributed network includes a plurality of hosts and a shared communication channel. Each host has a storage device. U.S. Pat. No. 5,630,007 teaches a distributed network which includes a plurality of servers with storage devices and a plurality of clients. In U.S. Patent No. 5,630,007 the servers are distinct from the clients. In incasting the clients and the servers are interchangeable. Each host may act as either a client or a server. A file is divided into a plurality of segments. Each segment is transmitted to the storage devices of several of the hosts and stored in the storage device of the host. Each host is coupled to the shared communication channel. A host acting as a client requests that the other hosts acting as servers and collectively send all of the segments to the requesting client so that the requesting client can gather the segments together in order for the segments to self-assemble and generate a single copy of the file. At least one host has a global list with entries. Each entry contains all the necessary information about the file.

Referring to FIG. 36 an MPEG-1 program 710 includes multiplexed system packets 711, audio packets 712 and video packets. The MPEG-1 program 710 is encoded. The perceptual encryption system 720 includes a de-multiplexing module 721, a system data buffer 722, an audio data buffer 723, a video data buffer 724 and a multiplexing module 725. The system data buffer 722, the audio data buffer 723 and the video data buffer 724 are coupled to the de-multiplexing module 721. The multiplexing module 725 is coupled to the system data buffer 722 and the audio data buffer 723. The perceptual encryption system 720 also includes an encryption module 726 with a key. The encryption module 26 is coupled to the video data buffer 724. U.S. Pat. No. 6,038,316 teaches an encryption module. The encryption module with a key enables encryption of digital information. The encryption module includes logic for encrypting the digital information and distributing the digital information. U.S. Pat. No. 6,052,780 teaches a digital lock which is encrypted it with some n-bit key. In the case of a DES device the block size is 64 bits and the key size is 56 bits. U.S. Pat. No. 4,731,843 teaches a DES device in a cipher feedback mode of k bits. The output of the multiplexing module 25 is a perceptually encrypted MPEG-1 Program 730. The perceptually encrypted an MPEG-1 program 730 includes multiplexed system packets 711, audio packets 712 and low fidelity video packets 731 and refinement bit stream 732. The overall architecture for perceptual encryption includes a stream of the MPEG-1 program 10. The MPEG-1 program 10 is de-multiplexed, separating the system packets 711, the audio packets 712 and the audio packets 713. The system packets 711 and the audio packets 712 are buffered in the system data buffer 722 and the audio data buffer 723, respectively, and transferred to the multiplexing module 725.

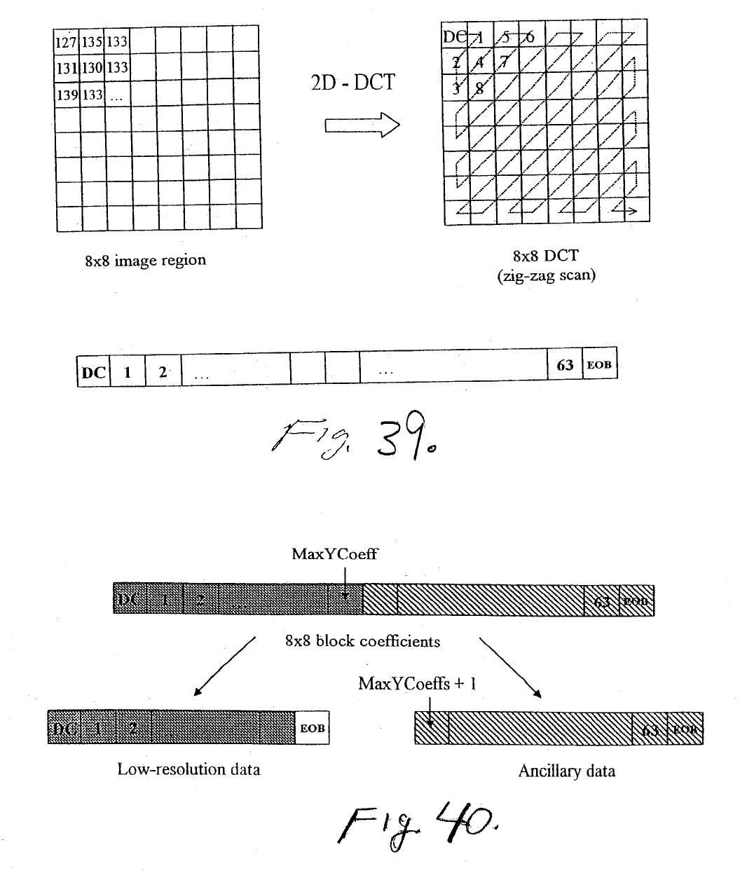

Referring to FIG. 37 in conjunction with FIG. 36 the encoding strategy consists in separating the spectral information contained in the video sequence across a first video sub-packet 741 and a second video sub-packet 742. The second video sub-packet 742 containing the refinement (high frequency) data is encrypted. To a decoder the non-encrypted first video sub-packet 741 will appear as the original video packet 713. The encrypted second video sub-packet 742 is inserted in the stream as padding data. This operation can be performed both in the luminance as well as in the chrominance domain in order to generate a variety of encoded sequences with different properties. It is possible to build a video sequence where the basic low-fidelity mode gives access to a low-resolution version of the video sequence. The user is granted access to the full-resolution version when he purchases the key. Perceptual encryption is applicable to most video encoding standards, since most of them are based on separation of the color components (RGB or YCbCr) and use spectral information to achieve high compression rates. Perceptual encryption allows simultaneous content protection and preview capabilities. It is safer than watermarking since it prevents intellectual property rights infringement rather than trying to detect it after the fact. Perceptual encryption is applied to video encoded under the MPEG-1 compression standard. The use of perceptual encryption is not limited to this specific standard. It is applicable to a large ensemble of audio/video compression standards, including MPEG-2, MPEG4, MPEG-21, MPEG-7, QuickTime, Real Time, AVI, Cine Pak and others.

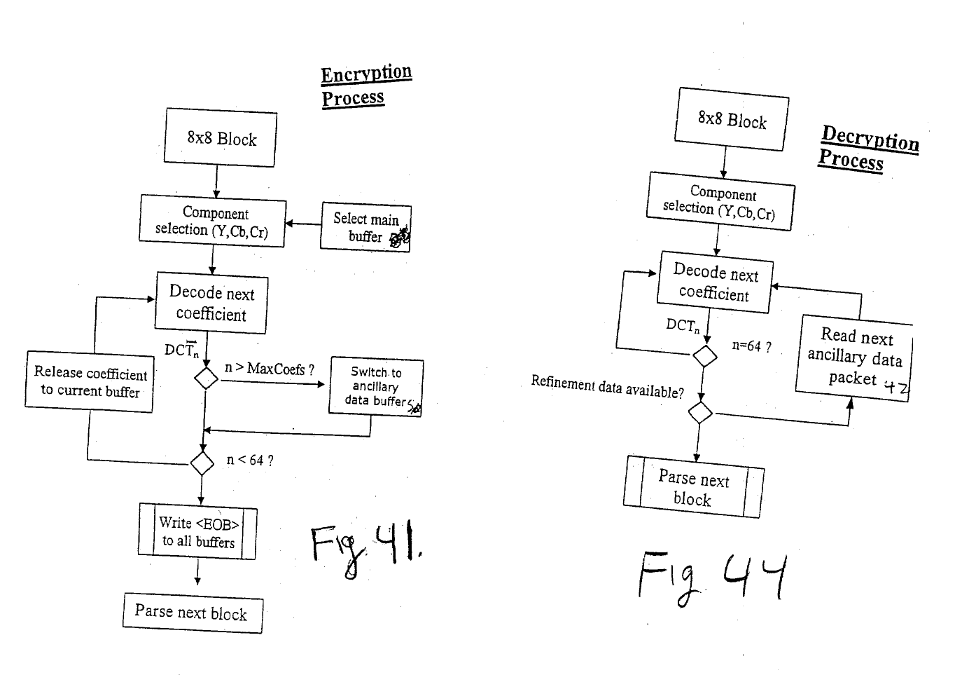

Referring to FIG. 38 an 8×8 pixel image area represents the basic encoded unit in the MPEG-1 standard. Each pixel is described by a luminance term (Y) and two chrominance terms (Cb and Cr). The only video format which the MPEG-1 standard supports is the 4:2:0 format. The chrominance resolution is half the luminance resolution both horizontally and vertically. As a consequence compressed data always presents a sequence of four luminance blocks which are followed by two chrominance blocks.

Referring to FIG. 39 a flow chart of the transformation from an 8×8 region to 8×8 DCT of each component is computed thereby returning 64 coefficients per component. The coefficients of each component are sorted in order of increasing spatial frequency.

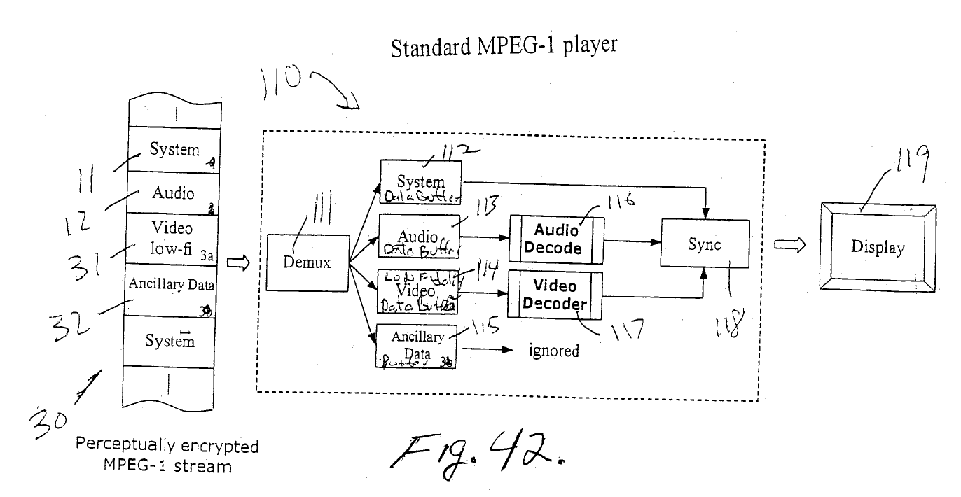

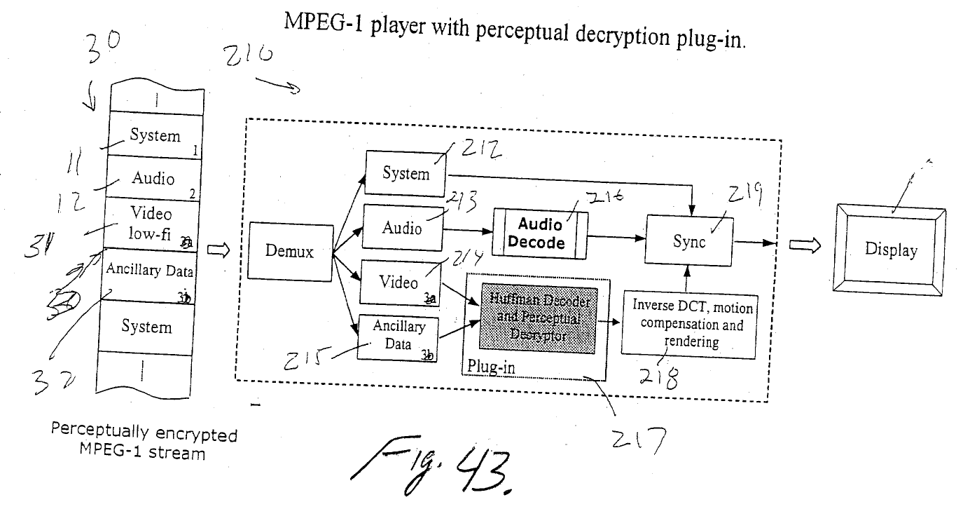

Referring to FIG. 40 in conjunction with FIG. 41 as the input bit stream is being parsed, a video packet 713 is identified and its 8×8 DCT coefficients are selectively sent to either a main buffer 751 or an ancillary buffer 752 in order to generate the low-resolution data for the main video packet 731 or the ancillary data for the refinement bit stream 732, respectively. The parameters MaxYCoeffs, MaxCbCoeffs and MaxCrCoeffs allow the content provider to S select the maximum number of Y, Cb and Cr coefficients, respectively, to be retained in the original bit stream. As soon as the maximum number of coefficients in the main video packet 731 for a given component is reached, an end-of-block (EOB) code is appended to signal the end of the current block. This is a crucial step since the Huffman encoded 8×8 blocks do not present any start-of-block marker and the EOB sequence is the only element signaling the termination of the compressed block and the beginning of the next. There are two different types of 8×8 data blocks encountered in the MPEG-1 standard. The first type occurs in I-pictures, which consist of frames where no motion prediction occurs. In these frames each 8×8 image region is compressed using a modified JPEG algorithm and the DCT of each of the components is encoded directly (intra-frame compression). In P-pictures and B-pictures, instead, one-directional or bi-directional motion-compensated prediction takes place to exploit the temporal redundancy of the video sequence. In these frames either some or all of the 8×8 image blocks are estimated from the neighboring frames and the prediction error is encoded using a JPEG style algorithm (inter-frame compression). Several strategies for applying different low-pass filters to intra-coded or inter-coded blocks were explored. The optimal solution applies identical low-pass filtering to both types of encoded blocks. The theoretical explanation of this result resides in the superposition-principle. It is a consequence of the fact that the DCT is a linear operator.

Referring to FIG. 41 in conjunction with FIG. 37 once the video packet 713 parsing is complete, the first video sub-packet 731 which is stored in the main buffer 751 is released to the output stream to replace the original video packet 713. The refinement video sub-packet 732 is encrypted and the stored in the ancillary buffer 752 to be released to the output as a padding stream. The function of the padding stream is normally that of preserving the current bit rate. Since the size of the combined first and second video sub-packets 731 and 732 is only slightly larger than the original video packet 713 the bit rate of the original sequence is preserved and the decoding of the encrypted sequence does not require additional buffering capabilities. A heading-generator generates a specific padding packet header 753. The padding heading 753 is used to insert the encrypted ancillary data 732 into the video stream. This allows full compatibility with a standard decoder since this type of packet is simply ignored by the decoder. A proprietary 32-bit sequence is inserted at the beginning of the ancillary data to allow the correct identification of the encrypted video sub-packets 732. Moreover since no limit on the size of the video packets 713 is imposed with the exception of buffering constraints additional data, such as decryption information, can be included at any point inside these packets. Perceptual encryption decomposes each of the video packet 713 into several sub-packet. The first sub-packet provides the essential conformance to the standard and contains enough information to guarantee a basic low-fidelity viewing capability of the video sequence. The first video sub-packet is not subject to encryption. Each of the second video sub-packet and all subsequent video sub-packets represents a refinement bit stream and, when added incrementally, serially enhances the “quality” of the basic video packet until a high fidelity video sequence is obtained. Each video sub-packet is encrypted and are placed back in the bit stream as padding streams. The standard MPEG-1 decoder will ignores padding streams. The definition of “successive levels of quality” is arbitrary and is not limited to a particular one. Possible definitions of level of fidelity are associated with, but are not restricted to, higher resolution, higher dynamic range, better color definition, lower signal-to-noise ratio or better error resiliency. The video packets 713 are partially decoded and successively encrypted. The main idea behind the perceptual encryption is to decompose each video packet 713 into at least two video sub-packets. The first video sub-packet 731 is the basic video packet and provides the basic compliance with the standard and contains enough information to guarantee low-fidelity viewing capabilities of the video sequence. The first video sub-packet 731 is not subjected to encryption and appears to the decoder as a standard video packet. The second video sub-packet 732 represents a refinement bit stream and is encrypted. The refinement bit stream enhances the “quality” of the basic video packet and when combined with the first video sub-packet 731 is able to restore a full fidelity video sequence. The second video sub-packet 732 is encrypted using the encryption module 726 and the key 728. Perceptual encryption includes the use of standard cryptographic techniques. The encrypted second video packet 732 is inserted in the bit stream as padding data and is ignored by the standard MPEG-1 decoder. Perceptual encryption encrypts high quality compressed video sequences for intellectual property rights protection purposes. The key part of perceptual encryption resides in its capability of preserving the compatibility of the encrypted bit stream with the compression standard. This allows the distribution of encrypted video sequences with several available levels of video and audio quality coexisting in the same bit stream. Perceptual encryption permits the content provider to selectively grant the user access to a specific fidelity level without requiring the transmission of additional compressed data. The real-time encryption for compressed video sequences preserves the compatibility of the encrypted sequences with the original standard used to encode the video and audio data. The main advantage of perceptual encryption is that several levels of video quality can be combined in a single bit stream thereby allowing selective restriction access to the users. When compared to other encryption strategies perceptual encryption presents the advantage of giving the user access to a “low fidelity” version of the audio-video sequence, instead of completely precluding the user from viewing the sequence. Since perceptual encryption acts on the video packets 713, as they are made available, encryption can be performed in real-time on a streaming video sequence with no delay. This result is from the fact that each video packet 713 is perceptually encrypted separately and the refinement bit streams for a specific video packet are streamed immediately following the non-encrypted low fidelity data. This feature is very attractive because it makes it suitable for real-time on demand streaming of encrypted video. Moreover keeping perceptual encryption distributed gives the encoded sequences better error resiliency properties, allowing easier error correction. In order to keep the overhead introduced by perceptual encryption as small as possible, no extra information related to the refinement sub-packets is added to the video packet header.

Referring to FIG. 42 a standard MPEG-1 player 810 includes a de-multiplexing module 811, a system data buffer 812, an audio data buffer 813, a low fidelity video data buffer 814, a refinement bit stream data buffer 815, an audio decoder 816, a video decoder 817, a synchronizer 818, and a display 819. The system data buffer 812, the audio data buffer 813, the low fidelity video data buffer 814 and the refinement bit stream data buffer 815 are coupled to the de-multiplexing module 811. The synchronizer 818 is coupled to the system data buffer 812 and the audio data buffer 813. The video decoder 817 is coupled to the low fidelity video data buffer 814. The synchronizer 818 is also coupled to the video decoder 817. The video decoder 817 may include a Huffman decoder and an inverse DCT, motion compensation and rendering module. The display 819 is coupled to the inverse DCT, motion compensation and rendering module. The standard MPEG-1 player 810 performs the input stream parsing and de-multiplexing along with all of the rest of operations necessary to decode the low fidelity video packets including the DCT coefficient inversion, the image rendering as well as all the other non-video related operations.

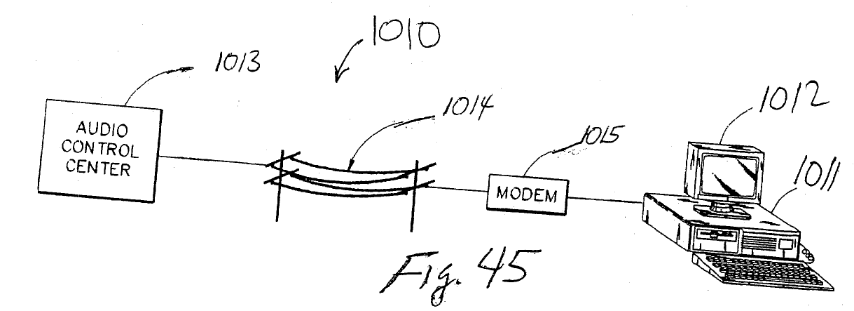

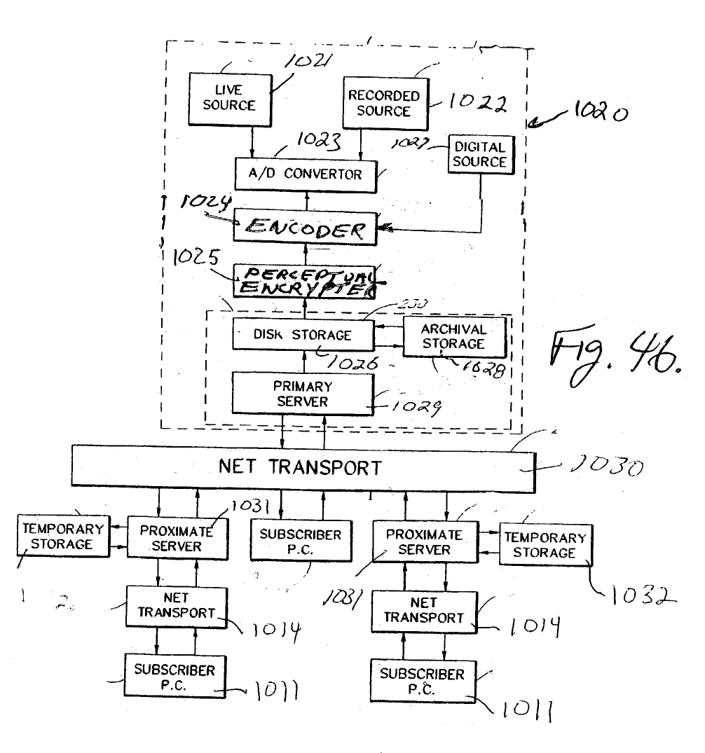

Referring to FIG. 43 in conjunction with FIG. 44 an MPEG-1 player 910 with a perceptual decryption plug-in includes a includes a de-multiplexing module 911, a system data buffer 912, an audio data buffer 913, a low fidelity video data buffer 914, a refinement bit stream data buffer 915, an audio decoder 916, a Huffman Decoder and Perceptual Decryptor 917, an inverse DCT, motion compensation and rendering module 918, a synchronizer 919 and a display 920. The system data buffer 912, the audio data buffer 913, the low fidelity video data buffer 914 and the refinement bit stream data buffer 915 are coupled to the de-multiplexing module 911. The audio decoder 916 is coupled to the audio data buffer 913. The synchronizer 919 is coupled to the system data buffer 912 and the audio decoder 916. The Huffman decoder and perceptual encryptor 917 is coupled to the low fidelity video data buffer 914 and the refinement bit stream data buffer 915. The inverse DCT, motion compensation and rendering module 918 is coupled to the Huffman Decoder and Perceptual Decryptor 917. The synchronizer 918 is also coupled to the inverse DCT, motion compensation and rendering module 918. The display 920 is coupled to the synchronizer. The plug-in to the MPEG-1 player 910 performs the input stream parsing and de-multiplexing. The standard MPEG-1 player 910 performs all of the rest of operations necessary to decode the low fidelity video packets including the DCT coefficient inversion, the image rendering, as well as all the other non-video related operations. The plug-in may be designed to handle seamlessly MPEG-1 sequences coming from locally accessible files as well as from streaming video. U.S. Pat. No. 6,038,316 teaches a decryption module. The decryption module enables the encrypted digital information to be decrypted with the key. The decryption module includes logic for decrypting the encrypted digital information. The standard MPEG-1 player 910 is coupled to a display 914. The plug-in replaces the front-end of the MPEG-1 player and performs the input stream parsing and de-multiplexing. The plug-in carries on all the operations necessary to decode the video packets 31 and 32 and perform decryption. Similarly to perceptual encryption decryption acts on one video packet at the time. Once the current video packet is buffered the system searches for its refinement sub-packets that immediately follow the main packet. According to the level of access to the video sequence granted to the user, the available refinement bit streams are decrypted and are combined with the original packet. The fusion of the main packet 31 with the refinement sub-packets 32 takes place at the block level. In decryption only additional spectral information is contained in the refinement data. This implementation represents a possible example of definition of multiple level of access to the video sequence, but decryption is not limited to a particular one. The encrypted bit streams contain refinement DCT coefficients whose function is to give access to a full-resolution high fidelity version of the video sequence. The fusion of the original block data with the refinement coefficients is possible with minimal overhead using the following process. Given an 8×8 image block, the Huffman codes of the main packet are decoded until an end-of-block sequence is reached. At this point the decrypting module 911 starts decoding the Huffman codes of the next refinement packet, if any is available. The DCT coefficients are then appended to the original sequence until the EOB sequence is read. Decryption continues until all the refinement packets are examined. In the special case of an additional sub-packet that does not contain any additional coefficient for the given 8×8 block, an EOB code is encountered immediately at the beginning of the block, signaling the decryption module 911 that no further DCT coefficients are available. In the implementation of decryption for the MPEG-1 standard player, the encrypted bit streams contain refinement DCT coefficients whose function is to give access to a full-resolution high fidelity version of the video sequence. The fusion of the original block data with the refinement coefficients is possible with minimal overhead using the following process. Given an 8×8 image block, the Huffman codes of the main packet are decoded until an end-of-block sequence is reached. At this point the decrypting module starts decoding the Huffman codes of the next refinement packet, if any is available. The DCT coefficients are then appended to the original sequence until the EOB sequence is read. Decryption continues until all the refinement packets are examined. In the special case of an additional sub-packet that does not contain any additional coefficient for the given 8×8 block, an EOB code is encountered immediately at the beginning of the block, signaling the decryption module 911 that no further DCT coefficients are available.

Similarly to the perceptual encryption the decryption takes place independently on each video packet, allowing real-time operation on streaming video sequences. As soon as all the refinement sub-packets, following the principal packet, are received, decryption can be completed.

A technology for encrypting high quality compressed video sequences for rights protection purposes resides in its capability of preserving the compatibility of the encrypted bit stream with the compression standard. The technology allows the distribution of encrypted video sequences with several available levels of video and audio quality coexisting in the same bit stream. The technology permits to selectively grant the user access to a specific fidelity level without requiring the transmission of additional compressed data. The technology is a real-time encryption/decryption technique for compressed video sequences. The technology preserves the compatibility of the encrypted sequences with the original standard used to encode the video and audio data. The main advantage of the technology is that several levels of video quality can be combined in a single bit stream allowing selective access restriction to the users. When compared to other common encryption strategies implementation of the technology presents the advantage of giving the user access to a “low fidelity” version of the audio-video sequence, instead of completely precluding the user from viewing the sequence.

The description of the technology has focused on the MPEG-1 standard in order to provide a detailed description of the technology. See ISO/IEC 11172-1:1993 Information Technology-Coding of Moving Pictures and Associated Audio for Digital Storage Media up to about 1, 5 Mbit/s-Part 1:Systems, Part 2:Video. The scope of technology is not limited to this specific standard. The technology is applicable to a large ensemble of audio/video compression standards. See V. Bhaskaran and K. Konstantinides. Image and Video Compression Standards: Algorithms and Architectures. Kluwer Academic Publishers, Boston, 1995.

In the MPEG-1 standard a high compression rate is achieved through a combination of motion prediction (temporal redundancy) and Huffman coding of DCT (Discrete Cosine Transform) coefficients computed on 8×8 image areas (spatial redundancy). See J. L. Mitchell, W. B. Pennebaker, C. E. Fogg and D. J. LeGall. MPEG Video Compression Standard. Chapman & Hall. International Thomson Publishing, 1996. One of the most important features of the DCT is that it is particularly efficient in de-coupling the image data. As a consequence the resulting transformed blocks tend to have a covariance matrix that is almost diagonal, with small cross-correlation terms. The most relevant feature to the technology, though, is that each of the transform coefficients contains the information relative to a particular spatial frequency. As a consequence cutting part of the high frequency coefficients acts as a low-pass filter decreasing the image resolution.

Referring to FIG. 45 an “audio-on-demand” system 1010 includes a subscriber personal computer 1011 which has a video display 1012. The subscriber personal computer 1011 may be an IBM personal computer having a 486 Intel Microprocessor. The subscriber personal computer 1011 connects to an audio control center 1013 over telephone lines 1014 via a modem 1015. In operation, a user calls the audio control center 1013 by means of the modem 1015. The audio control center 1013 transmits a menu of possible selections over the telephone lines 1014 to the subscriber personal computer 1011 for display on the video display 1012. The user may then select one of the available options displayed on the video display 1012 of the subscriber personal computer 1011. The user may opt to listen to a song or hear a book read. Once the audio data has been transmitted, the modem 1015 disconnects from the audio control center 1013. The subscriber personal computer 1011 has a microprocessor of equivalent or greater processing power than an INTEL 486 microprocessor (not necessarily compatible with an INTEL 486 microprocessor, a random access memory, a modem (external or internal) and a sound card (sound chip). The modem 1015 transmits data in the approximate range of 9.6 kilobits per second to 14.4 kilobits per second. The sound card serves as a digital-to-analog converter. The subscriber personal computer 1011 is advantageously capable of running MICROSOFT WINDOWS software. The personal computer should not be simply understood to be an IBM compatible computer. Any kind of workstations or personal computer will work including a SUN MICROSYSTEMS workstation, an APPLE computer, a laptop computer or a personal digital assistant.

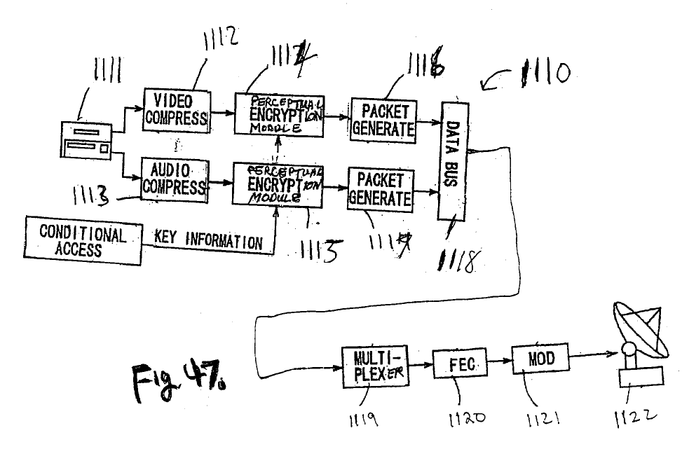

Referring to FIG. 46 the audio-on-demand system 1010 includes a distributing system 1020. The distributing system 1020 includes a live audio source 1021 and a recorded audio source 1022. The live audio source includes a person talking into a microphone or some other source of live audio data like a baseball game, while the recorded audio source 1022 includes a tape recorder, a compact disk or any other source of recorded audio information. Both the live audio source 1021 and the recorded audio source 1022 serve as inputs to an analog-to-digital converter 1023. The analog-to-digital converter 1023 may include a Roland® RAP 10 analog-to-digital converter available with the Roland® audio production card. The distributing system 1020 also includes an encoder 1024 and a perceptual encrytper 1025 and a memory storage device 1026. The encoder 1024 is a digital compressor. The perceptual encrypter 1025 perceptually encrypts the file of high fidelity audio data as encoded data in the lossy algorithm format in order to generate a file of restricted fidelity audio data as perceptually encrypted encoded data in the lossy algorithm format. The memory storage device 1026 stores the file of restricted fidelity audio data as perceptually encrypted encoded data in the lossy algorithm format. The analog-to-digital converter 1023 provides inputs to the encoder 1024. Of course, it should be understood that some audio data input into the audio control center 1020 may already be in digital form, as represented by a digitized audio source 1027 and may be input directly into the encoder 1024. The encoder 1024 compresses the digitized audio data provided by the analog-to-digital converter 1023 in accordance with the IS-54 standard compression algorithm. The encoder 1024 provides inputs to a perceptual encrypter 1025. The perceptual encrypter 1025 provides inputs to the memory storage device 1026. The memory storage device 1026 in turn communicates with an archival storage device 1028 via a bi-directional communication link. Finally, the memory storage device 1026 communicates with a primary server 1029. The primary server 1029 may include a UNIX server class work-station such as those produced by SUN Microsystems. The audio control center 1013 may communicate bi-directionally with a plurality of subscriber personal computers 1011 or a plurality of proximate servers 1031 via a net transport 1030. Each proximate server 1031 communicates with temporary storage devices 1032 via a bi-directional communication link. Each proximate server 1031 communicates with subscriber personal computers 1011 via net transport communication links 1030.

In operation, the analog-to-digital converter 1023 receives either live or recorded audio data from the live source 1021 or the recorded source 1022, respectively. The analog-to-digital converter 1023 then converts the received audio data into digital format and inputs the digitized audio data into the encoder 1024. The encoder 1024 may then compress the received audio data with a compression ratio of approximately 22:1 in accordance with the specifications of the IS-54 compression algorithm. The compressed audio data is then passed from the encoder 1024 to the memory storage device 1026 and, in turn, to the archival storage device 1028. The memory storage device 1026 and the archival storage device 1028 serve as audio libraries each of which can be accessed by the primary server 1028. The memory storage device 1026 contains audio clips and other audio data expected to be referenced with high frequency. The archival storage device 1028 contains audio clips and any other audio information expected to be referenced with lower frequency. The primary server 1029 may dynamically allocate the audio information stored within the memory storage device 1026, as well as the audio information stored within the archival storage device 1028, based upon a statistical analysis of the requested audio clips and other audio information. The primary server 1029 responds to requests received by the multiple subscriber personal computers 1011 and the proximate servers 1031 via the net transport 1030. The proximate servers 1031 may be dynamically allocated to serve local subscriber personal computers 1011 based upon the geographic location of each subscriber accessing the audio-on-demand system 1010. This ensures that a higher quality connection can be made between the proximate server 1031 and the subscriber specifications of the IS-54 compression algorithm. The compressed audio data is then passed from the encoder 1024 to the memory storage device 1026 and, in turn, to the archival storage device 1028. The memory storage device 1026 and the archival storage device 1028 serve as audio libraries each of which can be accessed by the primary server 1028. The memory storage device 1026 contains audio clips and other audio data which is expected to be referenced with high frequency. The archival storage device 1028 contains audio clips and any other audio information which is expected to be referenced with lower frequency. The primary server 1029 may also dynamically allocate the audio information stored within the memory storage device 1026, as well as the audio information stored within the archival storage device 1028, based upon a statistical analysis of the requested audio clips and other audio information. The primary server 1029 responds to requests received by the multiple subscriber personal computers 1011 and the proximate servers 1031 via the net transport 1030. The proximate servers 1031 may be dynamically allocated to serve local subscriber personal computers 1011 based upon the geographic location of each subscriber accessing the audio-on-demand system 1010. This ensures that a higher quality connection can be made between the proximate server 1031 and the subscriber personal computers 1011 via net transports 1030. Further, the temporary storage memory banks 1032 of the proximate servers 1031 are typically faster to access than the memory storage device 1026 or the archival storage device 1028 associated with the primary server 1029. The proximate servers 1031 can typically provide faster access to requested audio clips.

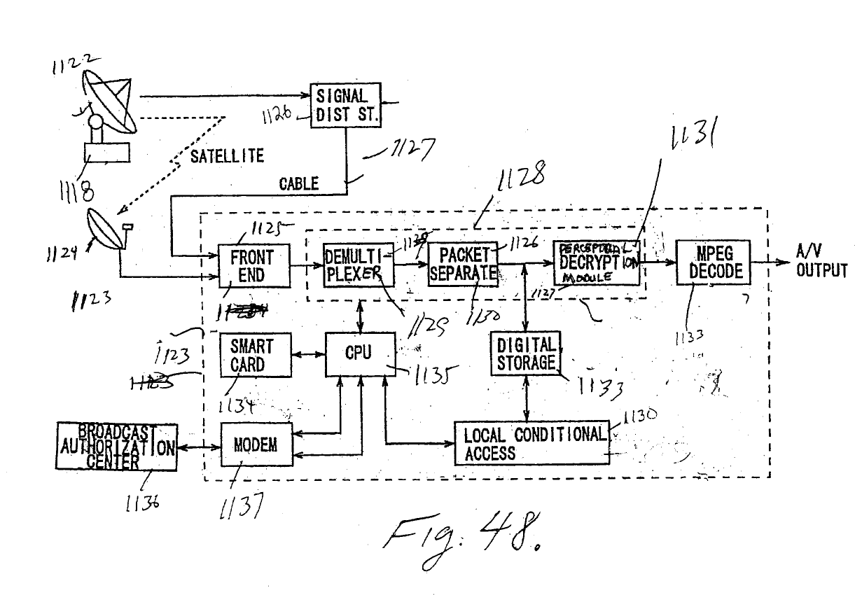

Referring to FIG. 47 a broadcasting station 1110 is a digital signal transmitting system 1110. A program source 1111 provides input to the broadcasting station 1110. The input is band-compression coded with a moving picture image coding experts group method by means of either a video encoder 1112 or an audio encoder 1113. The outputs of the video and audio encoders 1112 and 1113 are perceptually encrypted by means of a first perceptual encryption module 1114 and a second encyrption module 1115, respectively and converted to packet transmission data by means of a first packet generation section 1116 and a second packet generation 1117, respectively. The perceptually encrypted transmission data is transferred by a data bus 1118 and multiplexed by a multiplexer 1119. The perceptually encrypted transmission data is error corrected by a forward error correction (FEC) section 1120, modulated by a modulator 1121 and sent to a satellite 1122.

Referring to FIG. 47 in conjunction with FIG. 36 the MPEG-1 program includes multiplexed system packets, audio packets and video packets. The MPEG-1 program is encoded. The first perceptual encryption system 1114 includes a de-multiplexing module, a system data buffer, an audio data buffer, a video data buffer and a multiplexing module. The system data buffer, the audio data buffer and the video data buffer are coupled to the de-multiplexing module. The multiplexing module is coupled to the system data buffer and the audio data buffer. The perceptual encryption system 1113 also includes an encryption module with a key. The encryption module is coupled to the video data buffer. The output of the multiplexing module is a perceptually encrypted MPEG-1 Program. The perceptually encrypted an MPEG-1 program includes multiplexed system packets, audio packets and low fidelity video packets and refinement bit stream. The overall architecture for perceptual encryption includes a stream of the MPEG-1 program. The MPEG-1 program is de-multiplexed, separating the system packets, the audio packets and the audio packets. The system packets and the audio packets are buffered in the system data buffer and the audio data buffer, respectively, and transferred to the multiplexing module.

Referring to FIG. 47 in conjunction with FIG. 36 and FIG. 37 the encoding strategy consists in separating the spectral information which is contained in the video sequence across a first video sub-packet and a second video sub-packet. The second video sub-packet containing the refinement (high frequency) data is encrypted. To a decoder the non-encrypted first video sub-packet will appear as the original video packet. The encrypted second video sub-packet is inserted in the stream as padding data. This operation can be performed both in the luminance as well as in the chrominance domain in order to generate a variety of encoded sequences with different properties. It is possible to build a video sequence where the basic low-fidelity mode gives access to a low-resolution version of the video sequence. The user is granted access to the full-resolution version when he purchases the key. Perceptual encryption is applicable to most video encoding standards, since most of them are based on separation of the color components (RGB or YCbCr) and use spectral information to achieve high compression rates. Perceptual encryption allows simultaneous content protection and preview capabilities. It is safer than watermarking since it prevents intellectual property rights infringement rather than trying to detect it after the fact. Perceptual encryption is applied to video encoded under the MPEG-1 compression standard. The use of perceptual encryption is not limited to this specific standard. It is applicable to a large ensemble of audio/video compression standards, including MPEG-2, MPEG-4, MPEG-21, MPEG-7, QuickTime, Real Time, AVI, Cine Pak and others.

Referring to FIG. 47 in conjunction with FIG. 40 and FIG. 41 as the input bit stream is being parsed, a video packet is identified and its 8×8 DCT coefficients are selectively sent to either a main buffer or an ancillary buffer in order to generate the low-resolution data for the main video packet or the ancillary data for the refinement bit stream, respectively. The parameters MaxYCoeffs, MaxCbCoeffs and MaxCrCoeffs allow the content provider to select the maximum number of Y, Cb and Cr coefficients, respectively, to be retained in the original bit stream. As soon as the maximum number of coefficients in the main video packet for a given component is reached, an end-of-block (EOB) code is appended to signal the end of the current block. This is a crucial step since the Huffman encoded 8×8 blocks do not present any start-of-block marker and the EOB sequence is the only element signaling the termination of the compressed block and the beginning of the next.

Referring to FIG. 47 in conjunction with FIG. 37 and FIG. 41 once the video packet parsing is complete, the first video sub-packet which is stored in the main buffer is released to the output stream to replace the original video packet. The refinement video sub-packet is encrypted and the stored in the ancillary buffer to be released to the output as a padding stream. The function of the padding stream is normally that of preserving the current bit rate. Since the size of the combined first and second video sub-packets is only slightly larger than the original video packet the bit rate of the original sequence is preserved and the decoding of the encrypted sequence does not require additional buffering capabilities. A heading-generator generates a specific padding packet header 753. The padding heading is used to insert the encrypted ancillary data into the video stream. This allows full compatibility with a standard decoder since this type of packet is simply ignored by the decoder. A proprietary 32-bit sequence is inserted at the beginning of the ancillary data to allow the correct identification of the encrypted video sub-packets. Moreover since no limit on the size of the video packets is imposed with the exception of buffering constraints additional data, such as decryption information, can be included at any point inside these packets. Perceptual encryption decomposes each of the video packets into several sub-packets. The first sub-packet provides the essential conformance to the standard and contains enough information to guarantee a basic low-fidelity viewing capability of the video sequence. The first video sub-packet is not subject to encryption. Each of the second video sub-packet and all subsequent video sub-packets represents a refinement bit stream and, when added incrementally, serially enhances the “quality” of the basic video packet until a high fidelity video sequence is obtained. Each video sub-packet is encrypted and are placed back in the bit stream as padding streams. The standard MPEG-1 decoder will ignores padding streams. The definition of “successive levels of quality” is arbitrary and is not limited to a particular one. Possible definitions of level of fidelity are associated with, but are not restricted to, higher resolution, higher dynamic range, better color definition, lower signal-to-noise ratio or better error resiliency. The video packets are partially decoded and successively encrypted. The main idea behind the perceptual encryption is to decompose each video packet into at least two video sub-packets. The first video sub-packet is the basic video packet and provides the basic compliance with the standard and contains enough information to guarantee low-fidelity viewing capabilities of the video sequence. The first video sub-packet is not subjected to encryption and appears to the decoder as a standard video packet. The second video sub-packet represents a refinement bit stream and is encrypted. The refinement bit stream enhances the “quality” of the basic video packet and when combined with the first video sub-packet is able to restore a full fidelity video sequence. The second video sub-packet is encrypted using the encryption module and the key. Perceptual encryption includes the use of standard cryptographic techniques. The encrypted second video packet is inserted in the bit stream as padding data and is ignored by the standard MPEG-1 decoder.

Referring to FIG. 48 in conjunction with FIG. 47 the modulated data is sent either through the satellite 1122 directly to a signal receiving apparatus 1123 which has an antenna 1124 and a front end section 1125 or sent through the satellite 1123 to a signal distributing station 1126 called a head end. The antenna 1124 is installed in a contract user's household. The data transmitted to the signal distributing station 1126 is sent to the front end section 1125 via a cable 1127. When the transmission data is directly sent via the satellite 1122, the data is received by an antenna 1124 and sent to the front end section 1125. When the transmission data is sent from the signal distributing station 1126 via the cable 1127, it is inputted directly to the front end section 1125. A user contracts with the broadcasting station 1110 and accesses a key authorized to each user with respect to the transmission data sent directly from the satellite 1122 or from the satellite 1122 via the signal distributing station 1126. The user is authorized as a contract user and bill processing is performed. The transmission data is processed by the front end section 1125. The front end section 1125 includes a tuner, a demodulator and an error corrector. The processed data is input to a data fetch section 1128. In the data fetch section 1128, the multiplexed data is demultiplexed by a demultiplexer 1129 so that the data is separated by a packet separation section 1130 into a video data signal, an audio data signal, and a system data. In the packet separation section 1130 the data to be decrypted is packet separated. In a perceptual decryption moduilesection 1131, ciphers are decrypted while performing bill processing. Decompression of the data is expanded by an MPEG decoder 1132. The video and audio data signals are digital-to-analog converted to analog signals and are output to television. Incidentally, in the signal transmission system, when fee-charged software information such as video on demand or near video on demand is transmitted, a digital storage 18 such as tape media or disk media is incorporated in order to meet the convenience of users and to effectively utilize a digital transmission path. In such a case, large amounts of software data have been downloaded to the digital storage 1133 by making use of an unoccupied time band and an unoccupied transmission path. When the user looks at the software information at hand, the user accesses it with a smart card 1134 to perform bill processing and reproduction limitation is lifted. If the user accesses a central processing unit 1135 by means of the smart card 1134, the CPU 1135 performs an inquiry of registration to an authorization center 1136 through a modem 1137. The authorization center 1136 confirms registration by means of a conditional access 1138. If registration is confirmed, the authorization center 1136 performs bill processing and also performs notification of confirmation to the CPU 1135 through the modem 1137. The CPU 1135 instructs decryption of key to a local conditional access 1138 by this notification and the local conditional access 1138 decrypts a cipher which has been put over the data recorded on the digital storage 1133. Hence, the reproduction limitation is lifted, and the packet of the data recorded on the digital storage 1133 is separated by the packet separation section 1130. The compression of the packet-separated data is decompressed (expanded) by the MPEG decoder 1132 and the expanded data is digital-to-analog converted to be output to television as the analog signal and audio signal A/V output.

Referring to FIG. 48 in conjunction with FIG. 42 a standard MPEG-1 player includes a de-multiplexing module, a system data buffer, an audio data buffer, a low fidelity video data buffer, a refinement bit stream data buffer, an audio decoder, a video decoder, a synchronizer, and a display. The system data buffer, the audio data buffer, the low fidelity video data buffer and the refinement bit stream data buffer are coupled to the de-multiplexing module. The synchronizer is coupled to the system data buffer and the audio data buffer. The video decoder is coupled to the low fidelity video data buffer. The synchronizer is also coupled to the video decoder. The video decoder may include a Huffman decoder and an inverse DCT, motion compensation and rendering module. The display is coupled to the inverse DCT, motion compensation and rendering module. The standard MPEG-1 player performs the input stream parsing and de-multiplexing along with all of the rest of operations necessary to decode the low fidelity video packets including the DCT coefficient inversion, the image rendering as well as all the other non-video related operations.

Referring to FIG. 48 in conjunction with FIG. 43 and FIG. 44 an MPEG-1 player with a perceptual decryption plug-in includes a includes a de-multiplexing module, a system data buffer, an audio data buffer, a low fidelity video data buffer, a refinement bit stream data buffer, an audio decoder, a Huffman Decoder and Perceptual Decryptor, an inverse DCT, motion compensation and rendering module, a synchronizer and a display. The system data buffer, the audio data buffer, the low fidelity video data buffer and the refinement bit stream data buffer are coupled to the de-multiplexing module. The audio decoder is coupled to the audio data buffer. The synchronizer is coupled to the system data buffer and the audio decoder. The Huffman decoder and perceptual encryptor is coupled to the low fidelity video data buffer and the refinement bit stream data buffer. The inverse DCT, motion compensation and rendering module is coupled to the Huffman Decoder and Perceptual Decryptor. The synchronizer is also coupled to the inverse DCT, motion compensation and rendering module. The display is coupled to the synchronizer. The plug-in to the MPEG-1 player performs the input stream parsing and de-multiplexing. The standard MPEG-1 player performs all of the rest of operations necessary to decode the low fidelity video packets including the DCT coefficient inversion, the image rendering, as well as all the other non-video related operations. The plug-in may be designed to handle seamlessly MPEG-1 sequences coming from locally accessible files as well as from streaming video.

From the foregoing it can be seen that perceptual encryption and decryption of music and movies have been described.

Accordingly it is intended that the foregoing disclosure and drawings shall be considered only as an illustration of the principle of the present invention.

What is claimed is:

1. A system for transmitting a digital signal comprising:
a. an encoder for band-compression encoding a first digital signal as encoded data defining an image;
b. a perceptual encrypting system coupled to said encoder wherein said perceptual encrypting system perceptually encrypts said encoded data to generate restricted video data as perceptually encrypted encoded data; and
c. a transmitter coupled to said perceptual encrypting system wherein said transmitter transmits said perceptually encrypted encoded data.

2. A combined receiver and decoder for a restricted video data as perceptually encrypted encoded data according to claim 1, said combined receiver and decoder comprises:
a. a receiver which receives said perceptually encrypted encoded data; and
b. a decoder coupled to said receiver wherein said decoder decodes said perceptually encrypted encoded data to generate low quality video.

3. A combined receiver, perceptual decrypting system and decoder for a restricted video data as perceptually encrypted encoded data according to claim 1, said combined receiver, perceptual decrypting system and decoder comprising:
a. a receiver which receives said perceptually encrypted encoded data;
b. a perceptual decrypting system coupled to said receiver wherein said perceptual decrypting system perceptually decrypts said perceptually encrypted encoded data to generate encoded data; and
c. an decoder coupled to said perceptual decrypting system wherein said decoder decodes the file of encoded data to generate high quality video.
